(19) United States
(12) Patent Application Publication
(10) Pub. No.: US 2014/0346259 A1
(43) Pub. Date: Nov. 27, 2014

(54) RECEIVING, CONVERTING AND EMITTING BATTERY WORKING ACCORDING TO THE ACTIVE MAGNETOHYDRORESONANT EFFECT, METHOD FOR PREPARING HYDRORESONANT AND BIOMAGNETIC COMPOUNDS, METHOD FOR PREPARING THE BATTERY, AND GENERAL USE OF THE SAME IN THE MINERAL, PLANT AND ANIMAL KINGDOMS

(71) Applicants: Valmeron Martins, Centro. ljui RS. (BR); Pedro Jonas Koerich, Agronomica (BR)

(72) Inventors: Valmeron Martins, Centro. ljui RS. (BR); Pedro Jonas Koerich, Agronomica (BR)

(21) Appl. No.: 14/363,247

(22) PCT Filed: Dec. 3, 2012
(86) PCT No.: PCT/BR2012/000491

§ 371 Date: Jun. 5, 2014

(30) Foreign Application Priority Data
Dec. 5, 2011 (BR) PI-1107189-3

(51) Int. Cl. B05B 5/00

(52) U.S. Cl. CPC B05B 5/00
USPC 239/690; 29/428

(57) ABSTRACT

Magnetohidroressonate active effect receiving, converting, transmitting battery, process of preparation of the battery including hydroresonating and biomagnetic compounds, technical application in mineral, plant and animal kingdoms, the battery being formed from a mixture comprising hydroresonance, biomagnetic, polypropylene and black tourmaline, comprising 09 to 19% p/p of Hydroresonance, 81 to 89% p/p of polypropylene, Biomagnetic comprises 09 to 19% p/p of Hydroresonance, 18 to 39% p/p of black tourmaline and 67 to 84% p/p of polypropylene; the invention includes obtainment processes for the Hydroresonating s and biomagnetic compounds to be used in the battery, whose use and operation are endowed with particular features; in the invention, occurs the Ar/Light conversion, extracting vital cosmic energy from neutrinos, permanently converting and emitting natural long infrared, vital cosmic energy, negative ions (anions) Electromagnetic Conversion into negative waves is the MagnetoHydroresonating Active Effect radiates in fundamental particles in oscillating strings, resonant, pulsating and perpetuating.

This Patent request refers to the Magnetohydroresonating active effect Receiving, Converting and Transmitting Battery, negatively charged electromagnetic wave, pertaining to the physical/chemical energy sector formed by the so-called Hydroresonating solid and Biomagnetic solid compounds, physical/chemical energy sector. The Hydroresonating and Biomagnetic solid compounds injected in bands and mechanically coupled, form the Battery, the final product of this invention process, with properties of emitting natural long infrared, capturing and emitting vital cosmic energy and emitting negative ions (anions), such properties allow to increase the luminescence and to reduce intake in combustion processes, and the emission of greenhouse gases—GHG, to convert positive ions (cations) into negative ions (anions), negative Electromagnetic Conversion Wave, which maintains permanently in the form of pulsating and perpetuating strings, in the form of single particle, to neutralize the (malignant) action of the electromagnetic radiation, to reestablish and/or create a healthy environment where it's directly or indirectly present, through active diffusing or inert radiating vectors, by this new form of interaction and emission of energy on the planet and solar system.

The Vital Cosmic Energy, (immanent energy or universal energy), Generating Source of all things created in the Mineral, Plant and Animal Kingdoms, which Hippocrates called ‘vis medicatrix naturae’ (nature's vital force), which is in the essence of all things, interacts with all and is present in all existing physical/chemical/biological reactions that enable life on the planet as we know it. That is: the vital cosmic energy, or vital energy, interacts permanently in the physical/chemical reactions which occurs among the three kingdoms, at the same time combining them, mixing their properties, and also separates them, happening in the perfect moment and synchronically, and that also endows men with the perceptive ability to participate, Interact and act in the physical/chemical processes, accelerating some and decelerating other phenomena, some already known and mastered by men, who manipulate them according to their interests, which we call Science and by it catalogued as, for example: photosynthesis, electricity, magnetism, radium sciences and others which, throughout the report some of them will be commented, using the prototype of the subject of this laboratory patent, aiming to research and applying the prototype in physical/chemical processes, changing the outcome expected by science in similar experiments, fact understood as a real breach of the paradigms such as, for example: the combustion science, the harmonics in electricity science, the emission of positive ions (cations) by communication systems and in the process of electric energy generation, the salubrity/positive ionization/pH of the water, and more.

We live nowadays in the era of global communication, our biosphere is a sea of electromagnetic radiations and communication systems in all bands and frequencies, so that some frequency bands in the big cities are already saturated. Thousands of kW/hour of electric energy are consumed, transformed into electromagnetic waves by several communication systems through ether, such photon waves charged with positive ions (cations), revitalizes and are added to the positive ions (cations) of the pollutants' particles of greenhouse gases—GHG, produced by vehicle systems and thermal power generation systems and other industrial usages, producing the low ozone layer O³. And that way enhanced, stays for a longer time causing the already known unbalances in the biosphere.

These particles carried by the atmosphere wind scatter these carcinogenic dioxins across the planet, degrading the environment, contaminating rivers, lakes, and groundwater and plants that return to men in the form of food of plant or animal origin. These anomalies affect the biorhythm of the terrestrial plasma, a kind of pacemaker, which normally resonates at a frequency from 7.83 to 13.5 Hz, responsible for the balance of the biosphere, the common condition of all life forms, also the brain of all vertebrates are endowed with the same frequency, the laws of constancy, nowadays men are subjected to constant exposure of artificial electromagnetic fields, such as communications systems, automation systems, transmission systems and electricity distribution, residential circuits intensified by emissions from appliances, cause many health imbalances.

What has also been happening on the planet is the melting of the glaciers, death of large coral reefs, forests in Europe have more than 50% of their areas degraded by air pollution and acid rain, and the decline in agricultural production, food with no vigor and contaminated by pesticides, children with compromised bone structure and mothers producing milk with pesticides from agricultural sources (USP) are consequences of changes in the frequencies of the biosphere. Many scientific studies have been performed in an attempt to control these imbalances, using material from the mineralogy area especially black tourmaline crystals, many devices have been developed based on their properties of emitting negative ions (anions) and natural long infrared, but these studies are restricted to bands of UV (Ultraviolet) and IVL, (long infrared), generating many patents that use these crystals in their natural state in the form of ceramic chips or in mixtures, with operation restricted to the site in which they are installed. In pursuit of technological innovation capable of standing up to the environmental imbalance which mankind has been through, fuel and communication, we have developed an innovative technology able to gather in a single matrix, ability to return the natural frequencies of the planet. The origin of the imbalances is in the origin of the electricity production, generating positive ions (cations), used by men without correction and in the combustion of fossil and renewable fuels, which also generate positive charged ionization.

All investments for the usage of fossil fuels including its reserves are threatened by the effects of greenhouse gases—GHG, which emit, especially if the expansion forecast imposed by the demographic demand is maintained, at some point will collide into the limit of the environmental and thermal sustainability balance of the planet, thus resulting in the scrapping of the entire park installed on the 5 continents depending on these fuels to operate and all fossil fuel reserves abandoned.

### General Purposes of the Invention

In the research for the creation of the innovative technology, it's been sought to recreate the water anomalies that reproduce the natural biorhythms of the planet, associated with purified and enhanced crystals from black tourmaline dust, extending and expanding its band of operation, enhancing the ability to convert positive ions (cations) into negative ions (anions), in all bands of the electromagnetic spectrum, creating a negative electromagnetic wave applied to the energy that powers the machines the communication signals generation systems, have their effect transported and perpetuated. through these systems for any environment within its action radius, thus neutralizing the harmful effects at the origin of these signals, producing pre-electronic, healthy environments and within the natural biorhythm of the Earth between 7.83 and 13.5 telluric Hz. Reduce consumption and emissions of greenhouse gases GHG, neutralize the electrostatic charge of positive ions generated in combustion processes, ionize negatively the dust of mineral and limestone rocks to be used in the fertilization of soil correction with the purpose of more abundant producing agricultural crops, and at the receiving site, produce new pre-electronic, unpolluted and healthy environments.

Something new in science technology innovation needed to occur something that would enable to leverage mankind from impasses that have been reached, in continuing the current cycle of economic growth and limit exploitation and usage of natural resources of the planet, pressures imposed by population growth, demands for increased food production, more power generation and expansion of communications services, basic segments of social-economic development sustainability. Basic segments, but which are the cause of global warming, and the impasse that somehow generates delays in expansion decisions, which is believed to be the cause of this global economic slowdown.

Studies and Patents of Products with Properties of Black Tourmaline:

In his doctoral thesis José Maria Leal, conducted a survey on the use of Black Tourmaline Dust, where he presents various aspects of the use of this mineral in the development of new areas of technological innovation, analyzing hundreds of patents it's evident the use of the emission properties of long infrared, and emission of negative ions (anions) within a band range restricted from UV (ultraviolet) to IVL (long infrared), and that, in all patents, the products shown are mixtures or ceramic compounds with crystals dust in nature, with action restricted to short distance and local static and does not radiate through conductor vectors and with the inconvenience of the volume of mineral applied to have a significant effect.

The “Tourmaline is a mineral”—considered the stone of a thousand colors, due to the various colors that it can show and when it has transparency and is colored with a defined tint and good balance between hue and saturation, reaches values of thousands of American dollars per gram. This thesis refers to the black tourmaline, which unlike colored tourmaline is abundant and has a low value. It is common to use it even to cover dirt roads with gravel. The black tourmaline can occur in any geological environment, which explains its abundance. Its use in the jewelry industry is restricted. It is used in the manufacture of balls, bead of necklaces or used in other types of mineral crafts. Interest in black tourmaline in the international market appeared in the mid-1990s, mainly in the Far East Countries. This thesis was motivated by the interest of Brazilian Entrepreneurs exporters of black tourmaline. They want to better understand this emerging market, and perhaps add value to black tourmaline.

The pyroelectric properties can be observed by heating the sample, when the value of its spontaneous polarization changes and it's observed this variation. Most of the surface of a tourmaline crystal has affinity for negative charges. Negative atmospheric electric particles adhere to its surface until the neutralization of the electric field produced by the spontaneous polarization. Like any pyroelectric crystal, it's also piezoelectric, a mechanical stress is applied in such way to mitigate the spontaneous polarization releasing the negative ions adhered to the surface. This may explain the generation of negative ions observed in crystals of tourmaline ([YEH, 2006], [WANG, 2004]),

The classical theory on fluctuations of systems with multiple degrees of freedom ([LANDAU, 1971]), in the case of harmonic vibrations, foresees that, to the frequencies of normal oscillations particular to the ωα. . . , ωβ frequency system, are superimposed additional oscillations ωα±ωβ frequency (including duplicate frequencies and null frequency, the latter corresponding to a constant elongation). The spectrum in the tourmaline's infrared region shows oscillations of OH1 hydroxyl at site W, between 3620 and 3700 cm−1. This gives us an estimate for ωα−ωβ of approximately 2.1012s−1, with a wavelength of about 0.1 mm, in the limit band between the far infrared and the microwaves. That is, by classical mechanics, it is expected indeed an emission by the tourmaline crystals of electromagnetic waves in frequency of about 2.103 GHz “But this is a second-order phenomenon and should he of low intensity”.

The South Korean patents requested, KR 2003066531-A Bioceramic compound; KR 2003398696-B Textile fiber; KR 2004041989-A Production of porous magnetic minerals; 2004098808-A Polypropylene strands with antibacterial actions; KR 200410796-A Functional insole for shoes; CN 1488807-A Emission of far infrared and negative ions of oxygen; CN 1504147-A Functional ceramics for health; 20044238454 JP-A Fan with tourmaline devices to generate anions and eject them into the environment, JP 20044242852-A Device to remove NOx from vehicular emissions; JP 2004224031-A Far infrared emitting ceramic; JP 2004245206-A fuel modifier, JP 2004362893 coaxial cable covering to improve signal transmission; US 20041974 19 Therapeutic treatment and massage; US 20052241.26-A 1. Coating for water pipe; US 2005284020-A1 Material for breaking clusters of xylene on fossil fuel. CN 1564338-A Increase in battery life; KR 2005062480-A antibacterial brick, BR 9706181-A Soap, 9903343-A, Additive for compresses, both use the crystals in its formulation in the natural state.

Found in the LEAL's thesis, as is evident, that all patents are mixtures or ceramic compounds with crystals dust in nature, and require a large amount of basic raw material to work by having static effect within a small restricted radius and not radiating through diffuser vectors, to meet a greater market it would require a large amount of mineral present, economically unviable for the sustainability of the planet.

(LEAL, José Maria. Dust Technology of Black Tourmaline. 2008. Doctoral Thesis in Material Engineering of REDEMAT).

### Introduction of the Technology:

The Descriptive Report of the invention of the Receiving, Converting and Transmitting Battery, result of the interaction and joint action of the Hydroresonating and Biomagnetic solid compounds mechanically coupled, form the subject of the invention, the Receiving, Converting and Transmitting Battery, which produces a new form of energy interaction with the planet, what we call Magnetohydroresonating Active Effect. Conversion of Air/Light Energy with usage of the Vital Cosmic Energy (Immanent Energy) and astrophysical telluric energies captured and converted from Neutrinos, (Scientific Publication ArXiv.//arxiv.org/abs/1109.4897^{ν2}), by means of the modified-water based Hydroresonating compound's band, one of the Battery parts and with mechanical coupling with the Biomagnetic compound's band which has in its composition the multi crystals of black tourmaline, complete the Battery. And for the Black Tourmaline being called Magnetite or magnetic stone in its etymology, and the water molecules in motion generate energy that many call static which is resonating, justifies the name magnetohydroresonating.

This Magnetohydroresonating active effect which the emission in a single fundamental particle resonating to the sum and the interaction of the Vital Cosmic Energy, Natural long Infrared and pulsating and perpetuating negative ions, acting through the BATTERY, its work can be proved, by making physical/chemical changes, anywhere on the planet, without being present at the place, using radio systems, and internet as diffusing or transmitting/receiving mean.

Using any communication system, treating the generating energy with Batteries, you can transmit their signals Converted into electromagnetic waves charged with negative ions anions), which can be measured at reception anywhere on the planet or solar system.

It was also used a battery prototype, and through an inert diffusing vector the Magnetohydroresonating active effect was irradiated in sugar cane crop during the growing cycle of the plant until the harvest. Its broth, after going through the fermentation and distillation process, produced the cachaca able to reproduce the Magnetohydroresonating active effect, that is, capable of radiating and increasing the concentration of negative ions (anions) in any environment and neutralizing positive ions (cations) generated by devices that emit non-Ionizing Radiations such as a computer or Tablet

### Detailed Description of the Steps and Processes and Obtainment of the Hydroresonating and Biomagnetic Compounds and Their Solidification, Forming the Battery:

a. Obtainment Process of Hydroresonating Water and Solidification:

The First Step:

One objective of this invention lies in the obtainment process of Hydroresonating water made of potable water preferably added with ⅓ or 1/12 of rainwater, collected without backfill with the soil, volume used is between 57 and 120 liters variable determined by the ionization of the rain water (Used instrument Air Ion Counter—1000 ions/cm³—ALPHA LAB INC.) this water being impregnated with various elements from nature such as minerals, trace elements such as Al, Ha, Cu, Cr, Sr, Mn, Zn, Be, Mg, Ne, F, Br, S, K, Na, Ca, and others, this mixture, after the homogenization time required for each batch subjected to an outdoor floating oscillating rotation process, with neutral electromagnetic field, with time from 2 to 12 hours, forms macromolecules without remaining residues to the environment; the impregnated water becomes Hydroresonating in a new quantum state with electronic network connected with hydrogen anomalies fluctuation between 57 and 65, [“U.S.”] and keeps the frequency of free water molecule in motion with a permanent negative charge.

(“Bibliography: Evidence of a New Quantum State of Nano-confined. Water G. F Reitr, A. U. Kolesnikov, S. J. Paddison, P. M. Platzman, A. P. Moraysky, M. A. Adms, J. Msyers.arXv”).

The Second Step:

Another objective of this invention lies in the process of solidifying the Hydroresonating compound, which is the incorporation of Hydroresonating water energy, in physical/chemical form through agglutination technique, in the granules of virgin polypropylene polymer within a special electromagnetic field with rotation from 12 to 36 vortices by thermal sinusoidal waves, with evaporation between 21 and 210° C. the resulting nano micros incorporated into the polypropylene granules, related to the impregnation with the minerals happens in a percentage (%) related to 1 kg of sample: Al (from 0.0058758 to 0.0182469), Ba (0.0000698 to 0.00013466), Cu (0.0000407 to 0.0000881), Cr (0.0003635 to 0.0003771), Sr (0.0000358 to 0.0001313), Mn (0.0001617 to 0.0003346), Zn (0.0086550 to 0.0024102), Be (0.0005415 to 0.0018166), Mg (0.0192150 to 0.0257325), Ne (0.0005243 to 0.0012188) and traces in ppm. F, Br, S, K, which permanently keeps the oscillating energy of earth's natural electromagnetic frequencies between 7.83 and 13.5 telluric Hz (Schumann Resonance), and may vary according to the geodetic point. The polypropylene granules with embedded technology have the ability to extract from Air/Light and to store from neutrinos the Vital Cosmic Energy, which is released along with negative ions, polypropylene granules are injected in Hydroresonating bands of converting battery, receiving stations to be coupled in Biomagnetic Compound bands.

b. Description of the Invention Process of the Biomagnetic Compound.

First Step:

Another objective of this invention is the Biomagnetic compound, which lies in the obtainment process of pure and reinforced crystals of black tourmaline dust, which contains in its composition several elements such as boron, sodium, lithium, iron, aluminum and many other elements, the multicrystals subjected to the processes developed in the oven, through reductive oxidation, through a sintering and mutation process of the enhanced area, with thermodynamic fluctuations oscillating between 120 and 750° C., are purified and enhanced from 57 to 357 times their natural state, many of these elements which are undesirable and unnecessary for the proposed function are eliminated in this process.

Second Step:

It is a further objective of this invention the Biomagnetic solid compound, which lies in the solidification process through the combination of the pure and Hydroresonating water enhanced crystals, causing a mixture of the two basic components of from 1:9 QSP to 5:15 QSP, activating, high density Hydroresonating primordial soup, the tempered crystals are subjected to a evaporative centrifuge with fluctuating temperatures from 21 to 210° C., subjected to an electromagnetic field in the form of rotation between 12 and 36 vortices and agglutinative technique, with inverse rotations between 1000 and 8000 rpm, preferably between 1,000 and 3.500 rpm, the activating merge into nano micron tubes within the virgin polypropylene polymer granules, with all mineral fillers of the activating, with the following percentage (%) related to 1 kg sample: Al (1.6456923 to 4.7570721), Ha (0.0020748 to 0.0023364), Cu (0.0005039 to 0.0011384), Cr (0.0007333 to 0.0027413), Sr (0.0002942 to 0.0008043), Mn (0.0133294 to 0.0308743), Zn (0.0041521 to 0.0244534), Be (0.0051791 to 0.00129834), Mg (0.0173375 to 0.5376657), Ne (0.0030513 to 0.0011668), Br (0.0165023 to 0.01099382), S (0.0010317 to 0.0046112), C (0.7026383 to 1.3632263), 0 (0.0100513 to 0.0369937), Fe (0.7356891 to 2.4381419), Ni (0.0612045 to 0.2269403), Si (1.4262848 to 3,2234101), K (0.0055605 to 0.0246689) and traces in ppm, F, Br, S, making them a homogeneous fusion of a safe and stable natural solid final product and able to maintain the positive and negative permanent poles. The polypropylene granules of the biomagnetic compound start to emit natural long infrared, vital cosmic energy and negative ions, to be injected in bands of converting battery in rectangular, spiral half-moon, half clamps models, with holes and pins enabling the mechanical coupling with Hydroresonating Compound which completes the Battery.

### Process of Preparation and Assembly, of the Magnetohydroresonanting Active Effects Receiving, Converting and Transmitting Battery:

The invention process of the Magnetohydroresonating Active Effect Receiving, Converting and Transmitting Battery, is formed from the assembly through mechanical coupling of two solid compounds. The Hydroresonating compound and the biomagnetic compound injected by thermo-fusion in a high pressure injection machine, of from 120 to 600 tons of closing, with injection speed between 15 and 93 kg/cm², preferably in mold cavities with capacity exceeding 15 g quantum mass, the bands can he rectangular, half moon, spiral and half clamps, with holes and pins that allow the mechanical coupling by pressure of the bands to each other, which forms the battery, the energy interactions of the two bands coupled by pins makes the Magnetohydroresonating Active Effect Receiving, Converting and Transmitting Battery; the new interaction of the coupled bands energies draws vital cosmic energy from the neutrinos, converts and emits permanently natural long infrared, vital cosmic energy and negative ions (anions) Electromagnetic Conversion waves in the form of fundamental particles and oscillating, resonanting, pulsating and perpetuating string bands

the Magnetohydroresonating Active Effect covers a frequency range that can reach from 0.1 μm to 100 km, can cover the entire electromagnetic spectrum, thus increasing the electro-optic Air/Light polarization range of the tourmaline, in different spectral ranges of electronic transition bands, reaching spaces with radio frequency of from 03 kHz to 300 GHz, and from ≦07 kHz to 720 GHz, inverted waves of negative bands, converting the electromagnetic charges charged with positive ions (cations) for it makes the conversion of these into negative ions (anions), gravitons, which are perpetuated in the surrounding means in any change of physical/chemical state and energy transfer within their reach, or is employed in the Electromagnetic conversion of the energy source generating these signals and is radiated through active or inactive diffusers which can be cables or metal or plastic wires, air flow, combustion flame flow and others.

In the active diffuser with flow of electrons or living or inert molecules the installed battery acts or radiates fundamental particles from its installation point in the diffuser towards the movement or energy flow direction, such as powered electricity conducting wires and cables, radio frequency signals, data package, fuel ducts (fossil or renewable), piped water ducts, liquid or gaseous cooling fluids, air flow, flow of combustion flame, people and animals and others. The battery applied in inert diffusers acts or radiates its energy in both directions from its installation point on the diffuser in a helical motion with a diameter of 6 m along the diffuser, produces a pre-electronic healthy environment, free of electromagnetic radiation.

In Geobiology there are cracks, fissures, faults in the underground, underground water circulation, water/sewer piping or buried electrical lines, change the constant electrostatic or electro atmospheric potential and electrical potential, also the emanation of radon gas with ionizing atmospheric effect from the underground and which power, destructive and harmful to health, is fully demonstrated, telluric radiation, or electrical differential can be measured through electronic instruments, magmetômetros, Geiger counters, galvanometers, piezoelectric sensors, the anomalies arising from the underground are able to induce and incur upon the balance of living beings, such as plants and animals causing imbalance such as malaise, diseases and rickets.

The battery applied to the anomaly in the soil or using diffusers metal/plastic, neutralizes earth rays, eliminates differential electrical eliminates the unhealthiness caused by such anomalies, recreating a healthy environment, able to restore the balance of living beings that develop normally now on these sites.
(Bibliography: CNPq Projeta 558358/2009-8;—Bueno,Mariona, O grande livro da casa saudável/Mariano Buena.l translation from JoséLuiz da Silva l—São Paulo: Roca, 1995.—La influencia Del lugar sobre La vida, Prof. K. E. Lotz [Postfach 1641, D 7950 Bibberach/Riss, Alemanha]).

1—Example of the production of a basic rectangular battery: the two bands injected into the rectangular shape 8 cm wide, of length, 3 cm wide and 0.6 cm thick, with a mass of 15 g per mechanical coupling through pins, form the battery with a quantum mass of 30 gr.

The battery thus formed acquires the ability to draw power from the natural environment light permanently, emitting natural long infrared., vital cosmic energy and negative ions and to treat electrical systems which emit electromagnetic radiation, the positive ions (cations), performing the conversion of these positive ions (cations) at the generating source, into negative ions (anions), negative electromagnetic wave moment from which the electrical system starts emitting negative ions, across the entire network and the electronic equipment installed, revitalizing and promoting healthy environments, harmonizing and synchronizing the entire system, that is: the charge installed in the electricity supplied to the residence, synchronized and harmonized, presents consumption reduction from 5 to 15%, improves playback of audio and visual equipment for sound and TV, eliminates vibration and noise and brings useful life (of) to the equipment.

2—Example: The 30 g Battery is able to serve a residence offering with monthly consumption of up to 250 kWh, Larger consumptions are grouped up in series, by diffuser vectors in a quantity directly proportional to 250 kWh, used as reference the Battery of the application point on all wires and electronic equipment start transmitting negative electromagnetic waves to the environment with Natural Long Infrared, Vital Cosmic Energy and Negative ions (anions)=Clean Air “vitamin in the air”—clean the polluted air containing dust and particles, neutralizing those with positive charges (cations); Less stress—anions activate the β-endorphins in the human brain, which provides greater stability, comfort and happiness; Healthy Blood—anions eliminate the generation of active oxygen and oxidation of bodily fluids; Metabolism Activation—stabilize the autonomic nervous system, sympathetic and parasympathetic systems; Provides better activities of the internal organs, liver, kidneys, etc.; Increased organic resistance—increase the gamma globulin in the blood, which helps the body fight pathogens, all assisted environments get decontaminated and healthy.

3—Example: for a monthly consumption of 5.000 kW/h, it will be necessary to use 5.000/250=20 basic 30 g batteries. Or it can be inject bands with greater individual capacity, and produce more powerful batteries.

The Invention of the battery belongs to the mineral physical/chemical energy sector, the Hydroresonating and Biomagmetic Compounds after injected in band and coupled into batteries have their energy added, the Biomagnetic keeps the permanent positive and negative poles in its band. The multicrystals under pressure activate the ionic piezoelectric properties, and increase the pyroelectricity or electric potential, the electrode the band is potentially able to interfere with electromagnetic waves, it becomes a powerful transducer, enhancing negative ions with light polarization performs an electronic absorption in special spectrum bands enabled by the Hydroresonating band generate the MagnetoHydroresonating Active Effect, the battery produces and emits natural long infrared, receives and transmits vital cosmic energy and negative ions, this negative electromagnetic wave with the ability to cover the entire electromagnetic spectrum, thus increasing the electro-optical air/light polarization range of the tourmaline in different spectral ranges of electronic transition bands, increasing the spaces with radiofrequency of from 03 kHz to 300 GHz, and from 07 GHz to 720 kHz in negative bands frequency, and may radiate this energy through wires, diffusing cables, drinking/irrigation water, combustion air flow, forced movement air, cooling elements, electricity, communication systems, that is, this Great Technology Innovation is able to give dynamism to resources, with small quantum mass in form of converting batteries, perform works anywhere in the planet and/or solar system, by means of communication systems' diffusers.

4—Example: In the case of the transmission of radio signals, TV, cell phone, GPS, internet and satellite, applied to the MagnetoHydroresonating Battery in the energy supplying the generating source, the signals generated by the transmitter in the form of electromagnetic radiation waves, starts to carry ion negative (anions) charges, and where it is captured, the receiver will distribute negative ions (anions) into the environment, making it healthy, with air vitamins in resonant frequencies from 7.83 to 13.5 telluric Hz, laws of constancy, the one that flows in all healthy living beings on the planet.

The Technology of the MagnetoHydroresonating Active Effect in the form of Battery is powered by the energy of natural environment light, applied to the electricity externally, combustion air flow, water ducts, cooling gas ducts, the treated object transfers to the production line served its properties, impregnating or lodging itself in the products produced or treated.

The Technology of the MagnetoHydroresonating Active Effect is an energy field that works on the levels of electromagnetic conversion of positive ions into negative ions, with the ability to extract energy from telluric/astrophysical air/light, fixating it to be used in physical/chemical/biological activities with the hydrogen component, this will transmute its atomic structure, where the active effect once applied will be kept in sync with chords in permanent resonating pulse of negative ions, constructors of life of the mineral, plant and animal kingdoms, the emission of high speed fundamental particles interact with the ATP, Adenosine Triphosphate, help establishing a new hydrogen matrix leading to animals and humans adapting to new wavelengths of light. This new structure of the earthly universe will be ultrastructure of orbital relation of light to replace the atomic core, causing biochemical and biophysical changes in the internal structures, new hydrogen atom relation. The resonating fundamental particles emitted allow a wave vibration, produces hydrolysis simultaneously in bioenergy of living beings, the collision of a hydrogen atom with a molecule produces an entanglement, physical chemical reaction, simplest interaction phenomenon, break the hydrogen atom platonic transition orbital layers, this new state is perpetuated in the DNA and RNA of new generations of seeds, seedlings, and living beings born under the action of the MagnetoHydroresonating Active Effect, the hydrogen under these conditions acts especially in combustion systems.

### Current Situation of Reserves, and Use of the Fossil and Renewable Fuels:

The burning of fossil/renewable fuels and polluting industrial waste release sulfur dioxide (SO₂) and nitrogen dioxide (NO₂) in the atmosphere, components of the equivalent CO2 and on the soil. Said gases combine with the hydrogen present in the atmosphere in the form of water vapor, resulting in acid rain. The rainwater as well as frost, snow, and fog are loaded with sulfuric acid or nitric acid. When falling on the surface, they alter the chemical composition of soil and water, affect food chains, destroy forests and crops, attack metal structures, monuments and buildings. PH measures the concentration of positive hydrogen ions in a solution, the table ales from zero to fourteen: the higher the concentration of the ions, the lowest is the pH (more acidic) and therefore more acidic rain. In several cities of Western Europe and Eastern U.S., the rain has reached Ph between 2 and 3, that is, between that of the vinegar and lemon juice.

The pollution aggravates diseases such as asthma and pneumonia. About 4,000 people die every year as a result of air pollution in São Paulo, more than AIDS and tuberculosis added, affects infants, pregnant women, asthmatics, said Dr. Paulo Saldiva coordinator of the Experimental Air Pollution Laboratory, University of São Paulo Medical School.

The Industrial Revolution started in Europe in the eighteenth century led to the exhumation of coal buried millions of years aw, in gigantic proportions in order to power the newly invented steam engines and today 52% of all electricity consumed in the U.S. are from the burning of coal and similar or even larger proportions are used in China, Russia and Germany, it is estimated to have reserves of this fuel for more 400 years.

According to the International Energy Agency (IEA), in 2010 the exclusive emissions of CO2 were the largest in history, rising strongly after a sharp fall in 2009, attributed to the international financial crisis. On the other hand, scientists remain cautious about the 2° C. goal, stating that it's not a safety warranty and led by Joeri Rogelj, from the Institute of Climate and Atmospheric Science of Zurich. Switzerland, reviewed computer models based on the 2° C. goal. Many say they already realize noticeable changes in snow and ice cover, in habitat and reproductive patterns of migratory species because of an already observed warming, approximately 1° C. since 1900. “If the mechanisms needed in order to enable an early global emissions peak followed by intense reductions are not implemented there is a significant risk that the 2° C. target is not achieved,” the researchers warned.

In Brazil companies propose paths to a low carbon economy, proposing investment in research and development, public incentives and the use of more efficient technologies in the industry to reduce emissions of greenhouse gases—GHG, and boost the economy.

### Use and Method of Action of the Battery in Combustion Systems:

The use of MagnetoHydroresonating technology in the form of Battery in any combustion system, by extracting energy from the telluric/astrophysical Air/Light fixating it to be used in physical/chemical hydrogen activities, this will transmute the atomic structure, natural additive, triggers an energy field that works on the electromagnetic conversion of positive ions into negative (anions). Electromagnetic Conversion is applied in the combustion, in the air intake and/or fuel ducts, being kept in sync of chords in permanent pulse and producing the materialization of light, keeping a randomizing connector electromagnetic space-time (quantum vacuum), re-focus all the energy elevates the luminescence and the new hyper-dimensional orbital field, permanently neutralizing the combination of elements present in the combustion, thus reducing the emissions from 35 to 60%, so that most of the resulting gases, such as HC, CO, CO₂, NO₂, NOx, SO₂, O₃, MP, smoke and other gases such as benzene and dioxins, harmful to the biosphere, are ionized. with negative ions and reduces consumption from 05 to 15%.

### The Use of MagnetoHydroresonating Technology in Fuel:

The Use of Technology in the form MagnetoHydroresonating Battery in combustion systems of alternate and rotary movements of the Otto, Diesel, Braytone cycles, controlled external combustion systems, cooking system and others, the use of the Battery is set by the characteristics of each type of systems:

1—Otto Cycle. In Otto cycle engines with capacity of up to 2.0 L are applied 2 batteries, one at the air filter input and other at the fuel duct, which also connects to the battery's positive terminal cable, through an inert metal or plastic diffusing vector. For more powerful engines add up to a battery every 50 HP;

2—Diesel Cycle. In Diesel cycle engines with power of up to 50 HP are applied two batteries, one at the air filter input and other at the fuel duct. For more powerful engines, add a battery for each 50 HP in the air filter outlet at a 3:1 ratio, that is, for every 3 batteries applied in the air outlet of the filter, add one battery in the fuel system.

3)—In cooking combustion systems, in industrial systems or residential stoves, the batteries are applied in the form of clamps, directly on the hoses or pipes that carry the gas to the burners around 30 cm before the stove or oven. Experimental tests were performed with prototypes of the 15 grams battery in the form of clamps, in a residential stove with 4 and 6 burners, the consumption reduction was higher than 15% is attributed to the fact that the battery is very close to the stove and for having a slow flow, the Gas product remains longer receiving the MagnetoHydroresonating active ingredient and water used in cooking also improves conductivity and a lower boiling temperature, becoming ionized.

### External Combustion Systems—Special Chapter:

The use of MagnetoHydroresonating technology applied in the form of battery, in these external combustion systems that use many varieties of fuel requires a special discourse, following:

1)—In external combustion systems that use natural gas NG or LPG/GPL as fuel, such as boilers, drying ovens, kilns, drying chambers, heating systems and others, is held a combined application, in the combustion air outlet, the Batteries are applied in the firm of Curtains with Cut-outs, the number of units depends on the flow of m³ of combustion air consumed per hour, and around the gas conductor duct in the ratio of one to every 20,000 kcal/h, reduces consumption in about from 05 to 12% and the emission of pollutants, over 60% of greenhouse gases—GHG. in the specific case of boilers, through the treated combustion flame, the MagnetoHydroresonating active effect impregnates the steam generation ducts, thus reducing the hardness of water, dissolving salts, and reducing clogging and fouling problems.

2)—In External Combustion systems that use as fuel Heavy Oils such as APF, BPE, BTE, OC4 and Diesel oil, such as boilers, drying ovens, kilns, drying chambers, heating systems and others, it's performed a combined application, at the combustion air outlet, are applied Batteries in the form of curtains with Cut-Outs, the number of units depends on the p/m3/hr flow of combustion air, are also applied Batteries externally, around the oil conducting duct, in a ratio of one to every 10,000 kcal/h, or in the form of electromagnetic ionization, which reduces consumption in around from 05 to 12% and the emission of pollutants over 35% of greenhouse gases GHG, CO, CO2, NOₓ, SOₓ, smoke, reduces dioxins and other resulting gases. In the specific case of boilers, through external combustion flame, the MagnetoHydroresonating active effect, impregnates the steam generation ducts, and consequently reducing the hardness of water, dissolving salts, and reducing clogging and fouling problems.

3)—In External Combustion systems that use as fuel Coke, Pet Coke, such as boilers, drying ovens, kilns, drying chambers, heating systems and others, it's performed a combined application, at the combustion air outlet, are applied Batteries in the form of curtains with Cut-Outs, the number of units depends on the p/m³/hr flow of combustion air, are also applied Batteries externally, around the oil conducting duct, in a ratio of one to every 10,000 kcal/h, or in the form of electromagnetic ionization, which reduces consumption in around from 05 to 12% and reduces in over 45% the emission of greenhouse gases GHG, CO, CO2, NOₓ, Soₓ, MP, smoke, reduces dioxins and other resulting gases. In the specific case of boilers, through external combustion flame, the MagnetoHydroresonating active effect, impregnates the steam generation ducts, and consequently reducing the hardness of water, dissolving salts, and reducing clogging and fouling problems, also in the specific case of ceramic atomizers reduces the incidence of spots in the treated floors and porcelain, increasing its strength, becoming negatively ionized, that is. Eco healthy floors, with the reduction of fungi, mold, mildew where they are applied.

4)—In External Combustion systems that use as fuel Biomass, Bagasse, chips, barks, kernels, firewood and others such as boilers, drying ovens, kilns, cereal drying chambers, heating systems and others, it's performed a combined application, at the combustion air outlet, of Batteries in the form of curtains with Cut-Outs, the number of units depends on the p/m³/hr flow of combustion air, or in the form of electromagnetic ionization in belts and elevators, which reduces consumption in around from 05 to 10% and reduces in over 60% the emission of greenhouse gases GHG, CO, CO2, NOx, Sox, NIP, smoke, and other resulting gases, produces amorphous ashes, of higher quality. In the specific case of boilers, through the flame of the treated combustion, the MagnetoHydroresonating active effect, impregnates the steam generation ducts, and consequently reducing the hardness of water, dissolving salts, and reducing clogging and fouling problems, also in the specific case of cereal dryers, it keeps the quality and aggregates vitality to it. In the case of Coal, the resulting fine ash with low contaminants can be used in block industry or used to improve the quality of cement.

5)—In External Combustion systems that use as fuel Coal and Charcoal such as boilers, steel furnaces, kilns, heating systems and others, are applied at the combustion air outlet, Batteries in the form of curtains with Cut-Outs, the number of units depends on the p/m³/hr flow of consumed combustion air, and for the ionization of the coal breakers, thus occurring the ionization process with negative ions in the solid fuels, raising the luminescence and combustion efficiency in about from 08 to 12%, and reducing in over 45% emission of greenhouse gases (GHG, CO, CO2, NOx, Sox, MP, smoke, and other resulting gases. In the specific case of boilers, through the flame of the treated combustion, the MagnetoHydroresonating active effect, impregnates the steam generation ducts, and consequently reducing the hardness of water, dissolving salts, and reducing clogging and fouling problems. The resulting thin amorphous ashes, with low contaminants, can be used in the block industry or used to improve the quality of cement, which was confirmed by the Scientific Technical Report issued by the Laboratory of Coal from CIENTEC-RS.

Due to the action of the MagnetoHydroresonating active effect technology, the ashes or solid wastes from the combustion of solid fuels such as coal, charcoal, firewood, cereal husks, sawdust and bark of trees loose or bonded by pressure (pellets), result in ashes with a lower rate of SO₂ and NO_{X} in its composition, which can be used in construction or in the cement industry, produces a higher quality cement other binders if applied in battery in the electricity and water, used in the manufacture of beams or precast these improve their resistance by l N (Newton) and reduce the water absorption in more than 10% after drying

In the use of MagnetoHydroresonating Technology, Batteries can be applied in combination, in ducts and supplying pumps and solid, liquid and gas fuel supply of the ovens, internal combustion engines and propulsion turbines, used in land, sea and air vehicle systems, in the pre-combustion phase, the increase in the luminescence activates the efficient burning capacity, produces consumption reduction of from 05 to 15%, and reduces gas emissions in a proportion between 35 to +−60%, which generate carbon credits.

### Current Situation of Supply and Use of Electricity:

We live in a society that depends completely on electricity and electrical appliances such as lamps, showers, microwaves, refrigerators, stereos, computers, ATMs, credit cards, in industries machinery, equipment and engines controlled by sophisticated automation system and electrical control. Communication systems such as radio broadcasting, television, fixed/mobile telephony and internet that add comfort, safety and agility, connected to the electricity grid, dependent on electricity. It is scientific knowledge that electronic circuits generate harmonics which in turn generate a series of damage to the electricity generation, transmission and distribution systems, making the power factor of the system oscillate.

Harmonics also generate unpleasant noise, heating by Joule effect in conductors, components and equipment, in the system of the energy Concessionaire as well as in the conductors, components, machinery and equipment of the consumer, reducing the useful life of this installed electrical infrastructure of the Concessionaire and Consumers, The presence of voltage harmonics increases errors in data transmission, reduces the communication speed in the industry and induces current harmonics on the rotors of electric engines which produces pulsing binary responsible for the vibration of the machinery. The effects of voltage harmonics on equipment that use the network as signal timing, such as soft starters, for example, lead to disturbances that often originate the system reset. The electric energy system as a whole has yet another account to be settled, that is: Concessionaire with their conductors, components and equipment and the Consumer with their conductors, components, machinery and equipment are emitting sources of positive ions, harmful to life, causing a number of disturbances in the atmosphere and environment with negative impact on plants, animals and man.

### Use of Technological Innovation MagnetoHydroresonating Battery in Electric Energy:

The use of MagnetoHydroresonating technology in electric energy, the Batteries are applied without physical contact with conductive metals, is executed: 1—Attach the battery on the power cables that feed the system; 2—Or attach the battery on the outer cover of the system's electric switchboard, or through ionizing strips connecting the battery to the conducting cables; therefore, the battery starts to convert the emitting electromagnetic field of positive ions (cations) of the installation into negative ions (anions) negative electromagnetic conversion, spread throughout the electrical circuit of the installation, keeping the environment decontaminated, the air ionized and determining the reduction of fungi and bacteria spread, resulting in harmonization and synchronization of the system as a whole, reducing the generation of the harmonics' effects, reducing noise, vibration, loss of energy, joule effect, increasing the useful-life of the component, machinery and electrical equipment from the concessionaire and consumers and promoting the reduction of active and reactive energy consumption from 05 to 15%

In generation and long distance transmission, the circuits having a positive electromagnetic charge, converted into negative electromagnetic waves, by the action of MagnetoHydroresonating technology, losses from environmental ionization will be significant, smaller, optimizing costs ant: increasing the quality supply to final consumers.

### Scientific Technical Study With Battery Prototype:

The use of MagnetoHydroresonating technology in electric energy, is evident with the use of a prototype of the Battery used in a scientific technical work—UNIJUI/RS—MIG WELDING and AUTOMATIC MAG.

Abstract: “This study aims to evaluate the performance of a device which purpose is to reduce emissions of fumes and gases harmful to worker's health. In the case of the process carried out in the MIG/MAG welding machine, the prototype had positive results, achieving 60.5% reduction in the polluting gases. This reduction in the mass of pollutant gases favors the occupational health of any operator of the welding machines, as well as the whole environment around the workplace. “Other benefits such as greater penetration of the chord, Vickes hardness, tensile resistance, fewer spills, with greater use of the electrode wire, this only occurs due to the correction of electric energy, with the reversal of positive ions into negative” ELECTROMAGNETIC CONVERSION.

### [UNIJUI] Project:

Development of the Innovative Product for Pollutants Emission Reduction in Welding Process with Increased Energy Efficiency and Improved Quality of Weld Beads; Prof Dr. Gil Eduardo Guimarães.

### Current Situation of the Communication Systems:

All communications systems from generation, transmission and repeating stations of radio broadcasting, television systems, microwave transmission system, cellphones, internet, satellite and other forms, use electricity for their signal generation, and in all electromagnetic spectrums they suffer the consequences of electrical harmonics and are producing sources of positive ions (cations), as these electromagnetic waves in its entirety, and in all their lengths, are charged with positive ions (cations), space non-ionizing radiation which starts to circulate throughout the biosphere, fed by these systems and reaching all corners of the planet, radiation of which, because of its negative effects, alters, modifies, disrupts, disintegrates, destroys land, river, lake and sea flora and fauna (for example, the collapse of bees—CCD), acidifying soil, rivers, lakes and sea, melting glaciers, enhancing the greenhouse gases resulting from combustion, contributing for the destruction of the ozone layer, spreading across the planet as the air currents.

It is not known if the famous Einstein quote, stating that men would not survive more than four years after the disappearance of bees is authentic. But experts are unanimous in predicting that the end of the swarms would have catastrophic effects on mankind, severely impacting on agricultural production by lack of flowers pollination, mankind today follows that track. We live in the age of global communication, our biosphere is a sea of electromagnetic radiation and communications systems in all frequency bands, so much that some cell phone frequency bands in major cities are already saturated, and need to expand to even higher frequency bands, more destructive to life.

The use of mobile phones should kill more than cigarettes in some years, according to a study published online by Australian doctor, Vini Khurana, :neurosurgeon who has received 14 awards in 16 years, asks that people use the device as little as possible, especially when it comes to children. The doctor examined about a hundred scientific papers published on the subject to reach his conclusions. According to him, there are at least eight clinical studies that indicate a link between cell phone use and certain kinds of brain tumor: “There are already predictions that this hazard has more ramifications to public health than asbestos or smoking”.

Cell phones can cause cancer, says study performed in London on Aug. 30, 2007 exposure to mobile phone signals for just five minutes could stimulate a cell division process, according to a new study on the use of the device published in the last issue of “New Scientist”.

Those who live within 100 m of a cell phone antenna is 33% more likely to die of cancer than the general population, says research from Federal University of Minas Gerais. The engineer Adilza Condessa Dode, 52, crossed data on deaths from tumors between 1996 and 2006 in Belo Horizonte with areas where these people lived and the location of cell phone antennas. She elected tumors already associated to this type of radiation: prostate, breast, lung, intestine, skin and thyroid in a radius of up to a thousand meters from the antennas, the risk was higher, the cell phone you turn off, the antenna you don't.

To get an idea of the gravity of the situation, research done in Israel (a country with cutting-edge research in this area) by the Weizmann Institute of Science and published on the New Scientist website, concludes that exposure to mobile phone signals for just five minutes could stimulate a cell division process. This process occurs naturally in the growth and rejuvenation of human tissue, but also has a central role in the development of a malignant tumor. A team led by Professor Roily Seger, a researcher from the Weizmann Institute of Rehovot—Israel—has exposed rat and human cells to electromagnetic radiation with a frequency similar to that emitted by cell phones, but only one-tenth of its power. After five minutes, the researchers identified the production of kinasses (type of enzyme) regulated by extracellular signals (ERK 1/2), natural chemicals that stimulate cell division and growth.

The solution patented by the Brazilian researchers, Eng. Prof Dr. Luciano Vieira Lima and Msc. Sandra F. O. Lima is an application of the principles proposed by Michael Faraday in 1836, named Faraday cage or Faraday Shield. This device proposes to avoid magnetic interference in areas or equipment that shouldn't suffer influence from magnetic fields.

This is the crucial point that needs to be solved, namely, blocking radiation emanating from radio signals that reach the cell phone in order to prevent such harmful electromagnetic radiation to cause damage to the human body even when communication is established. The MagnetoHydroresonating technology with its property of negative electromagnetic waves converts, radio signals sources, starting to emit, from the transmitter to the receiver, electromagnetic waves with negative ions benefiting the environment where it is spread and users, mainly of mobile telephony.

### Use of Technological Innovation MagnetoHydroresonating Battery in Communications:

The use of MagnetoHydroresonating technology in communications happens in two or three ways: 1—Attach the battery on the power cables that feed the system; 2—Attach the battery on the outer cover of the system's electric switchboard, or through ionizing strips produced with the Hydroresonating quantum mass. The same procedure is performed for other energy sources that feed the converting generating system of radio, audio, video, images, data, internet, cell phone system, GPS and satellites signals broadcast, in any band range or reverse band which use electromagnetic waves to spread themselves, which are converted at the electrical source of positive ions (cations) into negative ions (anions), the ELECTROMAGNETIC CONVERSION wave, signals which will be transmitted and received in negative ions, in the form of pulsating resonating and perpetuating strings, the devices connected in system treated at the generating source as radios, televisions and mobile phones, internet do not affect the biology of users who are connected in this system, cell phone calls, generated from a Cell Site, with signals in electromagnetic waves converted by the MagnetoHydroresonating Active Effect, will be received anywhere in the solar system, by any receiver mean, in the form of negative ions that are emitted into the environment around the receiver making the environment healthy.

All of these already converted charges from direct, alternating or chemical—“energy-generating” current in its origin of generation, transmission, repeaters and receivers, which harmonize and synchronize the whole treated system, and when the transmission and retransmission are via ether, they charge the biosphere with negative ions, which act on greenhouse gases—GHG, charged with positive ions (cations) the technology reduces the action of these gases by converting them into negative ions (anions), that is, previously it was generated acid rain with negative effects on life, environment and economy, but now can restore the ozone layer and the natural pre-electronic environment, harmonizes the life of plants and animals, especially insects and of bees in particular, that have their guidance and communication systems guarded, preventing the collapse and allowing their recovery.

Regardless the transmission system and repeaters being via ether (sinderal) or cable, the same effect that happens in the atmosphere, will happen in recreational and occupational human environments such as residential, commercial, industrial, and others, receiving points of these signals in radio equipment, TV, cell phones, internet and GPS; now with electromagnetic fields emitting negative ions, vitalize these environments, promoting welfare and disposition for people. As for cell phones, the ELECTROMAGNETIC CONVERSION of radio signal in Cell Sites, eliminates the harmful effect that its constant use causes in people and the ecosystem by the microwave range in which it operates.

The action of the MagnetoHydroresonating Battery Technology installed in communication systems, adds benefits in energy and equipment useful-life saving, by eliminating harmonics, noise and vibration from the equipment, improves the quality of the audio, data, image and internet signal, from the generation, transmission, reception and retransmission in repeaters, improves the quality and extends the range of the audio, images and data signals, thus redwing the shadow area in radio, television, cell phones, by harmonizing and synchronizing the whole system.

### Electromagnetic Radiation and Its Effects on Men in Prolonged Exposure:

Human beings, when subjected to non-ionizing radiation fields (RNE) such as the previously described welders, steadily, like computer, radar system, telemarketing, radio broadcasting, television system, satellite operators, automation system controllers, aircraft pilots, astronauts, drivers, electricians and users of devices with artificial electromagnetic principles, feel tired and sluggish thinking and many enter into a state of depression because of the evident stress and problems like Repetitive Strain Injury and Work Related Osteomuscular Disturbances are constant, partial loss of memory (blank for a few seconds), dryness of the eyes (Computer Vision Syndrome—CVS), headaches, insomnia and dizziness, respiratory and digestive disorders. These anomalies resonant from alternating frequencies which are all nullified by using technology of Active Effect MagnetoHydroresonating in these systems.

### Use of MagnetoHydroresonating Technology, in Form of Battery in the Conversion of Electromagnetic Radiation:

The use of MagnetoHydroresonating technology applied to the battery at the power supply that feeds radar systems, telemarketing, automation system controllers, radio broadcasting, television systems, satellite systems, transport by land, sea, and space, aircrew, astronauts, the role of technology creates a pre-electronic environment by converting positive ions cations) into negative ions (anions), associated with the emission of natural long infrared, beneficial to the life of plants and animals, fueled by Vital Cosmic Energy, stimulates the production of β-endorphins, improves the biological functions of people with restful sleep, reduces stress, good mood, activation of cells, increases metabolism, psychomotor performance, blood circulation, reasoning, concentration, recovery from fatigue, strengthens the immune system, improves performance and productivity, with improvements in all areas of the animal and plant kingdoms, which are under the effect of the action/protection of the MagnetoHydroresonating technology, with consequent improvement in life quality, removes the unhealthy environment and keeps the air clean and with vitamin additives, normalizes the autonomic nervous or motor system and produces an invigorating effect on living bodies.

The MagnetoHydroresonating Battery's technology new negative electromagnetic wave applied for protection of the Animal Kingdom, produces through the orientation of Spins in the reproduction processes and coupling methods, creating a spiral effect that changes the behavior of the effect and structure of protons and electrons and hydrogen, causing the epithelial standard to transform to new frequency bands with transformation and enhancement of certain aspects in the DNA and RNA, increasing the adaptability in more electrically accelerated environments, with further Magnetic transversal bands, the electromagnetic fields modified or accelerated, and also perpetuate the new generation, allowing greater absorption of oxygen and metabolic changes in inhospitable systems. This will enable men and animals to survive in environments with high pollution loads from electromagnetic radiation of high magnitude, which may occur on Earth if it's confirmed a verticalization in its main axis, which should produce many climate and weather changes with severe influences in the plant and animal world.

### Current Situation of Water Supply and Quality:

Water is essential for life, it's substance found in greater amounts in living being, it represents about 70% of human body weight, and its shortage causes weakness or even death. It is essential and not infinitely available, which seems absurd, since it occupies 70% of Earth's area, 97% is salt water, only 3% of the total is freshwater and of these only 0.01% are from rivers and lakes, where it's available for use. The remainder is in glaciers, icebergs and very deep underground and because of its ability to dissolve almost all chemical elements and compounds, water in rivers and lakes or in deep wells contains several dissolved elements such as zinc, magnesium, calcium, and radioactive elements, and depending on the degree of concentration of these elements it may or may not be harmful, the so-called hard water.

The water is also threatened by pollution caused by contamination by insecticides and herbicides, drugs used in agricultural production and climate changes that man has caused. In addition to the danger posed to the health and welfare of man, environmental degradation is appointed by the World Health Organization as a major threat to economic development and has become an element of dispute between nations. A World Bank report of 1995 warned that “the wars of the next century will be over water, not oil or because of politics.”

The technology described in JP 20055061505 A describes a pipe manufactured based on tourmaline crystals to purify water, environmentally very costly, for the crystals must be present in the mixture of all the pipes to be produced, and JP-20055219980-A, material composition for concrete reinforcement construction and in this case, crystals must be part of the compound using a large amount of mineral to perform a local job.

### The Use of the MagnetoHydroresonating Battery in the Water:

The use of the MagnetoHydroresonating technology to improve water quality, the battery is applied externally in the form of clamp on the water conducting ducts in residential, commercial, and serial in industrial and irrigation systems, the action of the negative electromagnetic wave, of the MagnetoHydroresonating Active Effect, which absorbs all Infrared energy from the fundamental particles on water produces better conductivity, flow, turbidity, stabilizes the PH in basic values, restores vital energy of water (ionizing negatively) lost in chemical purification processes, reduces odors, breaks the hardness acquired, dissolved salts (softening) in the contact with the ground or in chemical processes performed by man and increases its drinkability. With its quantum sonic action of pulsating string of negative ions, it dissolves the salt complexes, neutralizes the hardness, reduces the “stone milk”, reduces clogging in steam systems, pipeline systems and oil extraction, it can be applied in Oil Extraction, conventional irrigation processes, in hydroponic crops, electrolysis, in cement agglomeration processes, revitalizes water through ionization and enables the improvement of its use on a large scale, so there is enough water in the future for human needs avoiding conflict by its scarcity.

Example E—Use of MagnetoHydroresonating Technology in the form of clamp shaped Battery with diameter ¾ inch, applied on the entry trestle duct of residences and small businesses, with daily consumption of 30 m³, it is enough to treat the entire volume of water used, ionizing it. For larger scale consumers or irrigation systems, are used Basic rectangular Batteries, applied in sequence or series around the conducting duct in amount to cover with the use of the technology all the volume to be treated.

### Current Situation of Agricultural Production, Agricultural Pesticides, Fertilizers and Others:

Plants in general nowadays are under the effects of harmful electromagnetic radiation that tends to increase by request of the demand for even greater frequencies (3G to 4G), therefore more penetrating and more harmful that, in chemical reactions in the atmosphere with greenhouse gases, generate acid rain, change the rain cycles, causing droughts, misbalance ecosystems, degrade the soil of its nutrients, interfere in the photosynthesis, cause the disappearance of bees, languish and delay the harvest and cumulative pesticide.

According to FAO, the UN's Organization for Agriculture, in the last 50 years 45% of the bee species have disappeared and since they provide valuable services in production, the disappearance of bees is troubling. This matter is so serious that the Ministry of Environment is stimulating research on the topic like the project “Conservation and Management of Pollinators for Sustainable Agriculture.” The equation is simple: The pollination by bees is responsible for 35% of global food production, which represents 220 billion dollars per year in the world economy. And according to FAO, the UN's Agency for Food and Agriculture, it will be needed to produce 70% more food by 2050, when the population will be 9.1 billion people. With today's population and still counting with a sizeable population of these insects, in some countries already being required manual pollination, further burdening the products, what will be the lack of this important natural element in the food chain, when the demand require the announced levels of 70%.

The degradation of ecosystem favors the proliferation of pests and the weakening of the soil, requires more applications of pesticides, fungicides and bactericides to combat them, and more applications of mulch and chemical fertilizers, that with the application of MagnetoHydroresonating technology in rock dust Ionization, the amounts shall be reduced, for the recovery of agricultural soils. Problem that seriously affects the energetic quality of Brazilian agricultural products, especially fruits that often have part of the products rejected by the international market, for not meeting the requirements of energy concentration (minerals and average Angstrom), sweetness (Brix degree), shine and intense color. Brazil is a major importer of wheat flour for not producing wheat with quality gluten (W) enough to confer the ability to manufacture bread, the so called bread wheat.

### The use of the MagnetoHydroresonating Technology in Form of Battery in Agriculture:

The use of MagnetoHydroresonating technology applied in agricultural production occurs through installation of the battery on the inert diffusing vectors without power, previously or using active diffusing vector irrigation systems, and supporting systems, cables and wires of vineyards, apple trees and other inactive diffusers, ionization of rock dust used as fertilizer or artificial fertilizers and soil pH corrective, through fundamental particles it carries water with Long Infrared, Vital Cosmic Energy and Negative Ions it's the Ionization, during the dry season the fertilization with ionized rock dust extends water availability.

In seasonal agriculture it's performed the installation of diffusers continuously, forming parallel rows equidistant from each other (5 m) in both directions throughout the agricultural area to be treated, and after installing the battery by attaching it to the diffuser along the rows with the first installed 25 m from the initial end and then at every 50 m. 20 units per ha, use will be the ionization of rock dust used in Natural fertilization because it has its prolonged cycle over 4 years.

In irrigation system, attach the batteries to the water duct, added according to the flow rate in m³h, and in case there's use of existing cables or wires, in some perennial crops install the batteries as described above. Once installed, the MagnetoHydroresonating Battery starts emitting 24 hours a day over the treated area natural long infrared, vital cosmic energy and negative ions (anions) increases the time and the capacity of photosynthesis, creates a protected area by blocking the action of electromagnetic radiation, converts the positive ions (cations) of the air and soil into negative ions (anions), making them available to the plant. Increases the plant's ability to absorb micro nutrients from the air and soil, improves phyto tonic effect, greater carbonic connection, generates more vigorous plants, better branching of roots and capillaries, gives plants larger leaf mass and chlorophyll, enables the plants to absorb and fixate nitrogen, increases nutrient reserves in the case of tubers, larger leaf mass and chlorophyll, improves reproductive and productive ability of the plant, anticipates crops, increases the Brix degree of fruits and stems, produces more nutritious fruits, stems, grains, seeds and horticultural products, with higher energy content of up to 8,100 A°, increases the CO₂ absorption, releases at the same rate more oxygen O₂ per hectare and produces abundant harvests of over 1.0% above the previous average.

The use of MagnetoHydroresonating technology in the form battery applied in the ionization of industrial fertilizers, or directly in culture in traditional cultivation of horticulture or hydroponic cultivation, in the cultivation of plants of the families of vegetables, grasses and perennial crops, increases the plants' ability to absorb micro nutrients from the air and soil, extends phyto tonic effect, produces higher carbonic connection, hydrogen and nitrogen, produces more vigorous plants, improves branching of roots and capillaries, which increases its anchorage on the ground, gives plants larger leaf mass and chlorophyll which enables plants to absorb and fixate nitrogen and increase the reserves of nutrients, larger leaf mass chlorophyll, improves reproductive and productive ability of the plant, anticipates crops, increases the Brix degree of fruits and stems, produces more nutritious fruits, stems, grains, seeds and horticultural products, with higher energy content of up to 8,100 A°, increases the CO₂ absorption, releases at the same rate more oxygen O₂ per hectare and produces more abundant harvests, over 10% above the previous average, we can get similar results by applying ionized rock dust as fertilizer or in combination with some of rocks derived from calcite.

In rock dust Ionization, the amounts shall be reduced., for the recovery of agricultural soils. Problem that seriously affects the energetic quality of Brazilian agricultural products, especially fruits that often have part of the products rejected by the international market, for not meeting the requirements of energy concentration (minerals and average Angstrom), sweetness (Brix degree), shine and intense color. Brazil is a major importer of wheat flour for not producing wheat with quality gluten (W) enough to confer the ability to manufacture bread, the so called bread wheat.

The use of MagnetoHydroresonating technology in the ionization of fertilizers, soil correctives, and rock dust applied, in cultures of sugar cane and sweet sorghum increases the development of stem mass and the amount of Brix degree in their juices, improves productivity of the alcohol or sugar per ton per produced hectare, they will be ionized perennially, improvements that are connected to absorption in the higher percentage of carbon, CO2 and releases the same percentage, the oxygen O2 in the atmosphere. In sugar cane intended for seedling multiplication the MagnetoHydroresonating active effect's technology spreads in the newly planted areas, increases phyto tonic effect and produces all the benefits described in the previous chapter.

In the cultivation of plants in the family of vegetables and/or grasses for the production of cereals such as wheat, corn, rice, beans, soy and others, the use of the MagnetoHydroresonating battery in the ionization of fertilizers, soil correctives, and rock dust applied, or by diffusing vectors, protects the crops and increases the energy content of grains to up to 8,100 A°, raises the pH to basic, produces grains with ability to produce superior quality oil and with lower acidity, anticipates crops with increased production and quality and larger grains more colorful appearance and intense shine, improves the storage time in saddlers leading to lower loss, produces grains with greater productive and reproductive abilities with phyto tonic effect on the cultivation of wheat and the action of the MagnetoHydroresonating Battery by permanent action of the natural long infrared makes it possible to produce grains with stronger gluten (W).

In perennial crops like coffee, cocoa, cashew, apple, olive and others, the use of MagnetoHydroresonating technology increases the energy content of fruits and seeds to up to 8,100 A°, raises the pH to basic, produces seeds with the ability to produce superior quality oil and permanently ionized and with lower acidity, increasing the Brix degree of fruits and seeds, anticipating crops with increased production and quality and larger fruits and seeds with a more colorful appearance and intense shine, allowing the voluntary delay of the cultivation and maintaining the quality, maintaining for longer the nutritive vigor of the fruits after the harvest, improving the storage time leading to lower loss and producing seeds with higher productive and reproductive ability, and higher phyto tonic effect.

The use of the MagnetoHydroresonating technology in the form of battery applied in sheds or agricultural crops guarding saddlers, through of active or inert diffusing vectors, connected to the Batteries, distributed throughout the area at a distance of 5 m between them, creates environment free from insalubrity, maintains the nutritional and germinant properties of healthy seeds and grains, adds energy and vitality to stored products, reduces the incidence of fungus, molds, yeasts, parasites and larvae and during the bulk storage or in bags.

The use of MagnetoHydroresonating technology, in the form of battery in the electrical energy, combustion systems, water systems used in industrialization processes, the product originated is impregnated with part of the properties of the MagnetoHydroresonating active effect, acquires energy and vitality that can be maintained beyond the time that it was previously given validity on the shelves, that is, products with improved validity term, energy, foods with nutritional quality and less loss. The transfer of properties from the MagnetoHydroresonating Active Effect's electromagnetic wave to the products may occur during the industrial action of drying ovens, cooking, in the production of distilled and fermented beverages, milk, juices, edible oils, production of wheat derivatives, in cocoa in the production of chocolate, coffee seed in roasting and grinding, in juices obtained from fruits and others; it's very evident the reduction of characteristic odors from plants, refrigerators, dairy, animal feed factories, lyophilization factories, milling systems and production of plant oils, which, in many regions the industrial plants are located in urban areas, and cause discomfort and disturbance to the surrounding environment bringing discomfort to the surrounding population; these odors are attenuated, but can be circumscribed to the industrial area with the use of ionized screens around. the Industrial plant and or treating the water from the decantation lake.

The MagnetoHydroresonating active effect technology applied in the production of seeds and seedlings of any plant species, has incorporated in the genes of seed and seedlings, the properties of the MagnetoHydroresonating Active Effect Technology, properties that are fixated and manifested in subsequent generations, becomes a bio stimulant with a higher phyto tonic effect, higher productivity and quality for properties acquired by seeds and seedlings in the generations that follow, and even the third generation.

### Current Situation of Metal Alloys and Electromagnetic Fields:

The Electromagnetic fields exert action as we have already seen, over all the kingdoms that strikes causing changes depending on the degree of immunity, radiation from each of the elements that constitute them, that is, whether mineral, plant or animal. It is known that materials from past decades, in which little or nothing existed that artificially generated these fields, the steel alloys showed superior quality to the ones we use today, at which time we have found out that very few regions of the world where these radiations fields do not arrive or via radio broadcasting, mobile telephone and satellites, in varying degrees of intensity, without geopolitical boundaries.

The atoms of metals when in steel/casting processes to form a steel/alloy bar, are at all times under the influence of a higher or lower electromagnetic field, exerting a certain action on these atoms, somehow altering their movements within the crucible when in a liquid state, and also during the cooling time, period in which we believe that changes the accommodation of these atoms to a small degree in the formation of the chain that characterize them, but enough to change their original features, which they naturally would have without the presence of these fields as occurred in past decades, the pre-electronics decades.

### Use of MagnetoHydroresonating Battery Technological Innovation in Steelworks:

The MagnetoHydroresonating Active Effect technology applied in transformation processes of the elements in the mineral kingdom, the Natteries applied to the feeding energy of the melting furnaces or Batteries grouped as curtain with cut outs applied in combustion air from steel furnace. galvanic processes MagnetoHydroresonating Active Effect, incorporates material or alloys, simple, complex or of noble metals, resulting from the transformation in all physical/chemical processes of melting, transformation, distillation, bonding, deposition of metallic and non-metallic alloys in welding processes. making it more resistant the metallic and non-metallic alloys and ferrous and non-ferrous metals.

A different situation occurs in the smelting of ferrosilicon alloys, aimed at transformers' cores, cast under the effect of the MagnetoHydroresonating Technology, the alloy incorporates their properties, acquiring the ability to permanently reproduce negative ions (anions), perform the Electromagnetic Conversion of electricity lowered or raised by such device.

The same process occurs in the fusion of hard aluminum, used in the manufacture of blocks and pistons for combustion engines, it can reduce by 30% the emission of greenhouse gases, also reduces consumption, thus creating the real possibility of the production of more efficient and environmentally friendly engines, with no alteration to manufacturing facilities in activity on the planet today.

The MagnetoHydroresonating Battery technology applied in the process of smelting and transforming technique of the elements of the mineral kingdom, it's applied to the electricity that feeds the melting furnaces, or a group of Batteries mounted as a curtain with cut outs in combustion air and/or ionization of the fuel used in steel furnaces, the MagnetoHydroresonating Active Effect increases the features such as tensile strength, shear, abrasive, to machining qualities and incorporates through electricity or assisted combustion flame, it's properties into material or alloys resulting from the processed smelting.

The curtain installed in the same way in the combustion air outlet of the casting furnaces in the production of these alloys in steelwork and metallurgy plants, improves its characteristics foreseen and regulated by the specific Brazilian Technical Standards—ABNT such as tensile strength, compression, shear, oxidation, aggregated by MagnetoHydroresonating active effect technology, in castings of metals and metallic alloys, improves endurance, facilitates machining, reduces oxidation and all other specific characteristics defined by ABNT.

### Current Situation of the Manufacture of Rubber Artifacts' Industrial Production:

The natural rubber extracted from rubber trees native to Brazil produces natural latex with two genes: Soft Gel and Hard Gel; it also has in its composition ionic calcium reticules, which are associated to nano particles, and other elements associated to latex made of negative ions, containing in its structure several elements of the periodic table, which gives it exceptional qualities to withstand extreme temperatures, returning to room temperature in just a few seconds.

Thanks to its special properties, natural rubber is used to manufacture more than 50 thousand products, such as tires, condoms, surgical material, wires, fabrics, adhesives and disposable gloves. Nearly 70% of world production is intended for the manufacture of tires with synthetic blends, made under the influence of electromagnetic fields, charged with positive ions (cations), changing the original features and many of the properties of these blends, resulting in products with lower resistance and durability.

### Use of the MagnetoHydroresonating Technological Innovation in the Form of Battery in the Manufacture of Rubber Artifacts:

With the application of MagnetoHydroresonating technology in the form of battery in the electricity, water vapor which runs the production lines for the manufacture of rubber artifacts, neutralizes the positive electrical charges, to create the pre-electronic environment, charges the atmosphere with natural long infrared, vital cosmic energy and negative ions, natural ionization, which aggregates, and restores the lost natural features of latex dividing the action of charges of positive ions generated by electromagnetic radiation fields and the action of the material added to it, it returns to the rubber its unique properties such as elasticity, fatigue resistance, improves the shore-A hardness, mania flexural strength, resistance to abrasion and all other features expected and defined by the specific NTB, in the production and processing of products derived from the extrusion or any other industrialization process, such as tires, hoses, shoe soles and adds the features expected and defined by ABNT, specific to all products directly or indirectly derived polymers and synthetic fibers, carbon fibers, improved impact resistance, abrasion resistance, compression, shear and tensile strength.

The MagnetoHydroresonating technology applied in the production of any product originated from alloy forming technique, in the Manufacture of Rubber Artifacts during the merging, part of the properties of the MagnetoHydroresonating active effect technology, such as the ability to emit negative ions (anions) and the ability to capture and emit vital cosmic energy, which is incorporated or lodged in the structure of the created product, properties acquired. by transfer, which now are permanently manifested.

The exclusive advantage of the MagnetoHydroresonating technology of transferring part of its properties, is that, with a small number of MagnetoHydroresonatings batteries applied on the manufacturing line at large scales, once distributed in the market, start to act with their properties acquired by transfer, in environments they are received, as capillary branch of the factory installed “mother” battery.

### Conclusive Abstract of the Descriptive Report on the Green Use and Applications

All known products circulating in the market without exception have a finite useful-life, with monthly or annual maintenance costs and periodic repairs, of an operator in order to work, consume electricity or fossil energy with frequent supplies, of an on/off switch and perform only the task for which they were developed and narrowly, because they depend on operators and one way or another they pollute the atmosphere with greenhouse effect gases GHG or electromagnetic radiation.

Fossil fuels are the basis for all investments in human resources and infrastructure, to develop, operate and expand the scientific, technological and economic progress that we witness idly and represented by the valuable and vast infrastructure installed on the five continents, in the form of industrial facilities, highways, railways, airports, ports, thermal power plants, telecommunications, information technology, drilling platforms, processing and distillation plants of fossil fuels, land, sea and air vehicles, coming and going carrying goods and services.

All this wealth, including fuel reserves, is threatened by the effects that the GHG gases, if maintaining the expansionary policies imposed by demographic demand, will at some point collide with the balance limit of the planet's thermal environmental sustainability, scrapping all installed facilities and all the reserves of fossil fuel, making life as we know it on the planet not viable.

The MagnetoHydroresonating Battery Technology with environmental vocation since its structuring and manufacturing leads the green concept to all activities, for it operates in all economic sectors known, especially in the energy sector the most critical, by reducing by up to 60% the emission of greenhouse gases—GHG emitted by solid, liquid and gas fossil/renewable fuel, and finally, by meeting the most pressing needs that require immediate solutions for economic growth with environmental sustainability.

This is not something similar to what is classified and labeled as a product, since the MagnetoHydroresonating active effect technology has an useful-life equal to that of polypropylene, subject to damage by only a few acids, creates no monthly costs, since it goes without periodical maintenance and repairs doesn't need an operator to work, its fuel is natural environment light that is free, it has no on/off switch and performs more than one task simultaneously, and 24 hours/day, features that put this technology far from the ordinary standard of what is known as product.

It can be anticipated that we are facing a new Technology, a new way of capturing and interacting with clean energy, which acts on the environmental imbalance, harmonizes and synchronizes electrical systems, enables to continue using the natural resources of fossil energy available, expanding the valuable installed infrastructure “perhaps” with the green endorsement of the MagnetoHydroresonating technology, maintaining the status of growth with benefits in production processes, increasing the production of food, machinery and required equipment, making hard water available for consumption, blocking the harmful electromagnetic radiation, especially of cell phones, reducing the harmonics of the electricity power grid, improving the range and quality of radio and TV signals, reducing the inconvenient shadow area of radio signals. TV and cell phones, adding energy in industrialized food, bringing the pH of the water and keeping it in acceptable values, bringing to negative the water ionization, increasing the brix degree of fruits, sugar cane and sweet sorghum, reducing the insalubrity of saddlers, reducing costs and increasing quality and productivity of agriculture.

The MagnetoHydroresonating Battery adds high-tech and brings significant benefits to all economic activities known when present, such as electromagnetic radiation, food toxicity by chemicals applied in agriculture, greenhouse gas—GHG emitted by vehicle systems and industrial chimneys generating acid rain, whose effects are already being shown, unbalancing the temperature of the oceans with consequences across the globe such as: winds, torrential rains in one region and drought in others, epidemics, disappearance of bees and others picture that threatens the possibilities of life on the planet.

The MagnetoHydroresonating Battery is formed by an innovative, environmental friendly, non-chemical, eminently physical, of physical action MagnetoHydroresonating in negative electromagnetic waves supported by three active ingredients that work twenty-four hours a day on the treated area, where the first active effect emits natural long Infrared beneficial to the life of plants and animals. The second active effect, emitter and converter of ions, converts positive ions (cations) that are unhealthy and harmful to the environment, plant and animal life into negative ions (anions), beneficial to the environment, plant and animal life. And the third active effect, which captures and emits vital cosmic energy (immanent energy) and negative ions (anions) and involves the two previous effects, enhances them and extends the reach of their action through the air over short distances, and over longer distances through diffusing vectors such as metallic and plastic wires, water and others, giving them mobility to the effect action, which may therefore be manifested at the extremes of these diffusing vectors.

This feature is very useful in agriculture, in the spread of the technology properties in wide areas of planting, using these diffusing vectors, mostly the plastic ones for their low cost (trellised, biodegradable plastic material that is integrated to the ground in two years), the already installed irrigation system, ionization of fertilizers and rock dust and others. Also useful in the application in dark and unhealthy environments such as deposits, saddlers, inside mines and caves, enabling to keep the MagnetoHydroresonating battery away, in the presence of natural light, its fuel.

It's a clean technology, of easy application and non-polluting, works similarly to a Battery, but only similar, for it is far from equal, since it works without costs and the unpleasant task of refilling, repurchasing and residual toxicity in draining, operating on the dreamed and desired principles of continuous mode of motion or power generation, which reduces installation, management, operation and maintenance costs, property that allows it to operate both in cities and within unexplored regions, very useful feature for its use in rural and agricultural areas where it contributes greatly.

The validity of MagnetoHydroresonating Battery is limited solely to the useful-life of polypropylene, plastic agent used as combiner. There are older prototypes of these Batteries working perfectly, as much as the latest manufactured. Important property, which is estimated to be perpetual, in defining cost/benefit, by attenuating by (6×12) 72 months the value of the acquisition, the only disbursement made, since it does not depend on operators or periodic maintenance to operate, which generate costs. Important qualities to be considered by companies at the time of acquisition, by the representativeness that the weight of the item has in household, business and industry economy in the composition of investments and or purchase costs.

Something new in the field of science in the area of technological innovation had to occur that would enable humanity to leverage the impasses reached in continuing the current cycle of economic growth and use and exploitation limit of natural resources of the planet, pressures imposed by population growth, increased demand for food production, greater power generation and expansion of communications services, basic segments of sustainable socio-economic development. Basic segments, but which are the cause of global warming, and by the impasse that it generates somehow creates delays in expansionist decisions, believed to be the cause of this global economic slowdown.

And it is precisely in these areas that the MagnetoHydroresonating technology operates exuberantly, breaking the impasse and enabling the necessary growth without damage to the planet, in the use of Fossil Fuels, of Agrochemicals, Pesticides, insecticides and Radio Microwaves for Communication. That is:

### 1—Feeding.

1.1—Current Situation: in agriculture we live the acceptance limit in the use of agrochemicals and pesticides, counting also on the help of what remains of bees, whose pollination service for free makes up for 85% of what is produced of food. A study coordinated by the Scientific institute of Agronomic Research in France estimates that the economic value provided by insect pollination is more than 150 billion Euros, equivalent to approximately R$360 billion or 10% of global agricultural GDP: The equation is simple: The pollination by bees is responsible for 35% of global food production, which represents 220 billion Dollars per year in the world economy in food production. And according to FAO, the United Nations Agency for Food and Agriculture, in the last 50 years 45% of the bee species have disappeared and since they provide valuable services in production, the disappearance of bees is troubling. And also according to FAO, the estimated growth in the supply of food for the year 2050 is 70% from current levels, when the population will be 9.1 billion people, generating a significant impasse between needs and possibilities for growth in food production.

1.2—Action of the Technology in Food Production:

The action of the MagnetoHydroresonating Battery in food production opens paths by matching production growth to the environment, with gains in quality and production per hectare, reduces the need for Agrochemicals, Pesticides and insecticides, by the permanent presence of the Natural Long Infrared, Vital Cosmic Energy and emission of negative ions (anions), which through the phyto tonic effect produces plants with more vigor, germination and root development, improves the absorption of nutrients from the atmosphere and soil, absorbs more CO₂, retains more carbon which ensures strength, and releases O₂ in the same proportion to the environment and blocks the area served from the effects of electromagnetic radiation.

The MagnetoHydroresonating Battery technology, has proven its efficiency, for example: in Fruits, soy, corn, beans, rice, wheat crops, Hydroponic Cultivation, Horticulture, Sugarcane, Sweet Sorghum, Vineyards, Saddlers and others. The performance of the MagnetoHydroresonating Active Effect that underlies the Technology on agricultural products, is significant because of the intimacy that the technology has with water, and plants present a high water content in their composition., and its presence in the soil is also significant, and therefore corrects the pH of the soil to basic at acceptable values and keeps it in that value while installed, it makes basic the Ph of plant sap, fruits, cereals, sugar cane, sweet sorghum and horticultural products, raises the brix degree of grasses, saccharine such as sugar cane and sweet sorghum, fruits like grapes, oranges, apples and peaches adds greater production per hectare, anticipates harvest and adds energy to the products, which is a major problem in Brazil when exporting food by the lack of energy of processed and in natura food products, reducing the need for application of agrochemicals, fungicides and pesticides and makes the food more organic, improves the taste of resulting food when consumed in natura or processed, keeps them on the crop or on the shelves for longer in good consumption conditions, reduces losses by maturity, improves the color and appearance of horticultural products and fruits.

In wheat because of the need of this grass for the presence of long infrared, the MagnetoHydroresonating battery may increase the gluten or W of the wheat through the permanent emission of long infrared, increase its storage durability, without requiring purges with pesticides which, in Brazil, very little is produced due to the weather conditions making Brazil dependent and a potential importer of this cereal. The MagnetoHydroresonating battery technology enables to get seeds and seedlings when applied successively until the third generation, with the properties incorporated into the DNA so that in future generations, these seeds or seedlings will not need the application of the technology in the fields for their cultivation, reproducing by themselves in their descendants, the properties of the MagnetoHydroresonating technology. “We suspect and so we are researching, that the active ingredient modifies the DNA being added definitively to the DNA of plants and animals, improving immunity, making them stronger, healthier, energized, becoming immune to the electromagnetic radiation, sturdier to fungi, bacteria, viruses, diseases, colds, flu and others”.

### 2—Energy.

2.1 Fuels.

2.1.1—Current Situation: regarding the energy activity of fuels, the impasse is even more critical if compared to food and communication, for being the mainstay of energy conversion. The Kyoto Protocol imposes limits on the emission of pollutant gases emitted. by land vehicle system, responsible for 20% of the total emissions, and by industrial chimneys, Steelwork and Thermoelectric Plants, which account for the remaining 80% of CO₂ emissions polluting the atmosphere. Are denied business licenses to new Thermoelectric Plants fueled by coal and diesel, while the ones in operation are pressured to close by government agencies regulating and supervising the Kyoto goals.

If we can no longer rely on nuclear reserves because of the obvious risks, and with the little coal/diesel reserves available for what they generate of acid rain and other environmental problems arising from its use, disabling Thermoelectric Plants fueled by these fuels, as in the nuclear infeasibility, fuels that support the essential Social/Economic development and also to where were and are faced all investments made today in research and technology development, such as terrestrial extraction structures, offshore platforms, in processing structures and distilleries, in industrial infrastructures installed on the 5 continents fueled by these fuels, and vehicle systems that move in a constant come and go through land, sea and air, the economy of the entire world.

Disable all industrial facilities and all supporting infrastructure which has cost trillions of dollars to mankind, administrate the social chaos that the forced. vacancy would impose to mankind, hunger and violence imposed by shortages arising from the gradual slowing of the economy, is what seems to where we tread.

The Kyoto protocol which brings together a group of Member Countries has set goals for reducing emissions of greenhouse gases—GHG, and links new operating permits to new GHG GGHGG emitting companies, the purchase of carbon, called “carbon credit” or else the planting of trees in areas equivalent to the emissions. However, this short-term solution, except higher court, resembles a blood transfusion, where the donor is the patient himself, because nothing external to the planets natural resources is added to it in terms of the effective solutions it needs, to relieve from the already unbearable pollution that plagues it, that is, granting carbon in the form of credit, guaranteed by the already meager existing forest reserves, so that more pollutants are emitted by new Industries, Steelworks and Thermoelectric Plants and every day more vehicles circulating, it will at a determined moment bring the system to a collapse. It is very commendable Kyoto's initiative, especially regarding the reforestation that will bring benefits within 10 or 15 years in the air quality, in the maintenance of watersheds and perhaps the reemergence of others, of flora and fauna. Benefit that does not coincide with the time of the license, for it requires from 10 to 15 years of maturation, period in which the planet has to carbon credit and solve by itself facing the emissions that will occur immediately to the date of the permit.

2.1.2—Action of the technology in fuels: It's precisely in the application of energy fuels, that the MagnetoHydroresonating Battery technology has more redemptive action. It opens way for the use of solid, liquid and gas fossil and renewable fuels by reducing the consumption from 5 to 12% and emissions by up to 60% of HC, CO, CO₂, NOₓ, SOₓ, and O₃ emitted by land, sea and air vehicle systems, chimneys of Industries, Steelworks and Thermoelectric Plants, it reduces the so-called particulates originating from the toxic smoke spewed over the cities, worsening the picture by reacting in the atmosphere, causing a drop of acid rain and all the environmental problems arising therefrom.

In other words, we are facing a technological innovation that promises to seal with a Green Stamp, all known fuels used in controlled burning either by Otto cycle engines, diesel engines, aviation turbine and solid, liquid and gas fuels furnace, “as an external source, providing the actual generation of carbon credit”, and reducing the consumption of these fuels between 5 and 20%, varying according to the type of fuel treated.

The possibility that this innovation brings in social/economic development, allows us to predict due to the extension of time available for research, development of safe ways of using nuclear power without waste and recovering available nuclear energy reserves for use in a distant future.

### 2.2—Electricity,

2.2.1—Current Situation: in electricity systems we have problems that persist and that science nowadays still doesn't have technology that can provide solutions, which are the harmonics. Generated by residential, commercial and industrial electrical and electronic appliances and equipment that needs Reactive Energy to work, but that is not consumed by them such as Computers, TVs, Micro Waves, Radio, Fluorescent Lamps, Stereo Systems, Refrigerators, Air Conditioner, Electric Arc Furnaces, Lifts and Water Pumps, which are divided into multiples of 3, 5, 7, 9, 11 the odd numbers and in multiples of 2, 4, 6, 8 the even numbers, of generation Frequency, which can be 50 or 60 Hertz, lagging behind. in corresponding multiples, the generation Current and Voltage. These harmonics start circulating throughout the system from the generation and cause many losses and damages to both the supplier and the consumers. Causes overheating due to the Joule effect, noise in engines and machines, and reduces useful-life of all connected engines and equipment of the consumers and all equipment from the supplier's power grid, overloads the system from the Generating source, the Transmission and Distribution Network, affecting Transformers, Switching system, Protection Systems and wiring.

2.2.2—Action of the technology in the electricity: in the electricity sector, the MagnetoHydroresonating active effect Battery technology, proves its efficiency, by reducing the effects of Harmonics, significant gains to the economy, such as: 1—Improves the efficiency and useful-life of all equipment that make up the of electricity generation, transmission and distribution network, reduces replacement, maintenance and repairs expenses for the wiring, protection, transformers and other equipment of the transmission and distribution lines of electricity concessionaires, and of residential, commercial and industrial consumers. 2—Improves the efficiency and useful-life of electrical and electronic residential, commercial and industrial equipment, reduces replacement, maintenance, repairs and power consumption expenses for these devices. 3—Improves the quality, strength and melting point time of the weld, reduces by 60.5% the toxicity of smoke from welding (fame black), reduces spatter and increases the depth of the weld. 4—Improves the quality and fidelity of image and sound equipment, by reducing vibration and noise caused by harmonics. 6—Improves power and propagation of radio, TV, cell phone, wireless and GPS signals and reduces the shadow area of the radio, TV and cell phone signals.

### 3—Communications.

3.1 Current Situation: we know that some equipment more than others, but all electronic devices emit electromagnetic radiation when in operation. However radio broadcast communication equipment which is supported by electromagnetic waves called carrier waves, which transport the signal in different frequencies which enables sound, image and data communication spread this radiation into the atmosphere and in all directions.

It's only possible to expand the already existing cell phones, AM/FM radio, TV, and GPS, if we use higher frequencies than those previously used, therefore, more penetrating and in even higher levels of microwave than those already in use, causing further damage to men, animals and plants.

The most evident example is the well-known phenomenon of Bee CCD—Colony Collapse Desorder, in which the electromagnetic radiation emitted mainly by cell phones, can be damaging the sensitive guidance system of bees, causing them to get lost in the Hive/Flower and Flower/Hive paths and therefore leave no trace. In a recent research conducted by Daniel Frave, from the Federal Institute of Technology in Switzerland, he ensures that electromagnetic signals bring consequences for the insect, The cell phones may be confusing and even killing the bees around the world.

The study done in 2009 and published in May 2011, shows that after hours of exposure to these signals the bees emit sound to leave the house. For the experiment, Favre recorded the sounds of bees exposed to electromagnetic signals emitted by cell phones and observed the production of sounds similar to what the bees produce when they leave their hive. According to the researcher, previous studies have shown that prolonged exposure to cell phones made the bees unable to find their way back to the hive, leaving it almost empty in from five to ten days.

Without exempt other possible causes such as pesticides, dioxins and parasites, it's believed to be the Electromagnetic Radiation emitted by the communication systems that are thrown in all directions via ether by the antennas, keeping in the atmosphere positive charges (cations), the great aggressor to life, mainly sensitive King insect, by both destabilizing, disorienting and attacking its sensitive guidance and communication system.

An Article Published in Planet Magazine issue #412 of January 2007—Dangerous Technology—Cell phone may leave men infertile—says the article and continues: Scientists form the Research Center of Cleveland, USA, ensure that cell phone use can impair the production of semen and cause sterility. The Electromagnetic radiation for what we have seen, in fact harms plants and animals, a fact that generates a serious and significant impasse as to the growth possibilities of communication services, that to be possible its expansion, it requires the release of even higher, more penetrating frequencies than the ones used currently that already cause many problems.

3.2—Action of the technology in communications: the application of the MagnetoHydroresonating Battery technology in communications opens way for the expansion of communication services, by acting as “source blocker” and Electromagnetic Radiation converter, enabling the recreation of the pre-electronic environment around the protected object, it improves signal quality, extends the reach of radio signals by reducing the shadow areas, applying the battery into the power grid that feeds the communication equipment, and after being generated by a base transmitting antenna treated it is transmitted to the receiver anywhere in the solar system with the new situation negative electromagnetic wave. The presence of the technology, in these facilities enables the release of new frequencies making viable the expansion of existing communication services, expansion of the number of cell sites, without restraints as for the place of installation, which now will bring environmental benefits by increasing the bombardment of negative ions (anions) into the atmosphere by the antennae, which will act on the positive ions (cations) present in the atmosphere, converting them into negative ions (anions), helping to reducing acid rain the collapse of bees, helping restoring the ozone layer, perhaps surrounding solar electromagnetic radiation, stabilizing the development of forests and agricultural crops and also reducing energy expenses between 5 and 15%.

1-39. (canceled)

40. Magnetohydroresonating active effect receiving converting transmitting battery, wherein is formed from a mixture comprising hydroresonance, biomagnetic, polypropylene and Black Tourmaline, comprising from 09 to 19% p/p of Hydroresonance, 81 to 89% p/p polypropylene, Biomagnetic comprises 09 to 19% p/p Hydroresonance 18 to 39% p/p and black tourmaline 67 to 84% p/p of polypropylene.

41. Preparation process of the battery, including the preparation step of the compounds for subsequent solidification and usage in the preparation of the magnetoHydroresonating active effect receiving, converting, transmitting battery in the preparation process of Hydroresonating and biomagnetic compounds, in the preparation process of the battery, and general its use in the mineral, plant and animal kingdoms, wherein the Hydroresonating water consists of potable water plus ⅓ or 1/12 of rainwater, collected without backfill with the soil, volume between 57 and 120 liters, variable determined by the ionization of rainwater is obtained by impregnating it with minerals Al, Ba, Cu, Cr, Sr, Mn, Zn, Be, Mg, Ne, F, Br, S and K, and the mixture is homogenized in batches subjected to an outdoor oscillating floating rotation process, with neutral electromagnetic field, forming macromolecules without forming waste to the environment in which the already impregnated water becomes Hydroresonating in a quantum state with electronic network connected to fluctuations of hydrogen anomalies between 57 and 65; solidify the Hydroresonating water, which is the incorporation of energy by the Hydroresonating water by agglutination technique, the granules of virgin polypropylene polymer within an electromagnetic field with rotating of 12 vortices per thermal sine waves with evaporation between 21 and 210° C., the resulting nano micron incorporated in the PP granules; impregnation with minerals is given in percent (%) related to 1 kg sample of: Al (0.0058758 to 0.0182469), Ba (0.0000698 to 0.00013466), Cu (0.0000407 to 0.0000881), Cr (0.0003635 to 0.0003771), Sr (0.0000358 to 0.0001313), Mn (0.0001647 to 0.0003346), Zn (0.0086550 to 0.0024102), Be (0.0005415 to 0.0018166), Mg (0.0192150 to 0.0257325), Ne (0.0005243 to 0.0012188) and traces in ppm, F, Br, S, K mg/kg in an 1 kg sample: keeps permanently the oscillating energy of Earth's natural electromagnetic frequencies between 7.83 and 13.5 telluric Hz (Schumamn Resonance), the polypropylene granules with the embedded technology are injected in Hydroresonating s bands to form the receiving, converting and transmitting battery, to be coupled with the Biomagnetic Compound band.

42. Preparation process of the battery, according to claim 2, to be used in the preparation of the magnetoHydroresonating active effect receiving, converting, transmitting battery, the preparation process of the Hydroresonating and biomagnetic compounds, in the preparation process of the battery, and general its use in the mineral, plant and animal kingdoms, wherein the solidification of the Hydroresonating water energies, purification and enhancement of black tourmaline powder crystals and the solidification of the multicrystals, Hydroresonating water in polypropylene; in the process of obtaining pure and enhanced crystals of the black tourmaline powder, which comprises in its composition of numerous elements such as boron, sodium, lithium, iron, aluminum and traces of other elements, the multicrystals subjected to the processes developed in furnace through reductive oxidation, and through a sintering process and mutation of the enhanced area with thermodynamic fluctuations oscillating between 120 and 750° C., they are purified and enhanced to a range from 57 to 357 times its natural state, many of these undesirable and unnecessary elements for the intended function are eliminated during this process; obtaining from the combination of pure and enhanced crystals with Hydroresonating water, it's performed a mixture of the two basic components at from 2:9 QSP to 12:15 QSP, activating, high density Hydroresonating primordial soup, the temperate crystals are subjected to a evaporative centrifuge under temperatures oscillating between 21 and 210° C., subjected to an electromagnetic field in the form of reverse rotation with from 8 to 36 vortices, of agglutination technique with rotation between 1,900 rpm and 8,000 rpm, preferably between 1,000 and 3,500 rpm, the activating are fused into nano micron tubes within the granules of virgin polypropylene polymer with the following mineral charges in percentage (%) related to 1 kg sample of: Al (1.6456923 to 4.7570721), Ba (0.0020748 to 0.0023364), Cu (0.0005039 to 0.0011384), Cr (0.0007333 to 0.0027413), Sr (0.0002942 to 0.0008043), Mn (0.0133294 to 0.0308743), Zn (0.0041521 to 0.0244534), Be (0.0051791 to 0.00129834), Mg (0.0173375 to 0.5376657), Ne (0.0030513 to 0.0011668), Br (0.0165023 to 0.01099382), S (0.0010317 to 0.0046112), C (0.7026383 to 1.3632263), 0 (0.0100513 to 0.0369937), Fe (0.7356891 to 2.4381419), Ni (0.0612045 to 0.2269403), Si (1.4262848 to 3.2234101), K (0.0055605 to 0.0246689) and traces in ppm, F, Br, S, mg/kg the Polypropylene granules with Biomagnetic charge is a natural stable and safe final product, able to maintain permanent positive and negative poles, the Biomagnetic compound granules are injected into rectangular, half-moon, spiral, half-clamps models, always allowing the coupling with Hydroresonating Compound of the other band.

43. Preparation process of the battery, according to claims 2 and 3, wherein the injection of solid bands of Hydroresonating and Biomagnetic compounds and Mechanical coupling in battery in which the polypropylene granules with energy charges of the Hydroresonating and Biomagnetic compounds are injected by thermofusion at high pressure from 120 to 600 tons of closing, with injection speed between 15 and 93 kg/cm2 preferably in injection mold with cavities with spaces larger than 15 g mass, the bands can be rectangular, half moon, spiral and half clamps, with holes and pins to allow mechanical coupling by pressure of the bands to each other, forming the MagnetoHydroresonating Activity Effect Receiving, Converting and Transmitting Battery.

44. Technical application of the battery in mineral, plant and animal kingdoms, wherein it is performing the Air/Light conversion, extracting vital cosmic energy from the neutrinos, converting and emitting permanently natural long infrared, vital cosmic energy, negative ions (anions) on resonating, perpetuating, oscillating and pulsating strings; the MagnetoHydroresonating active effect covers the frequency ranges from 0.1 μM to 100 km, increases the electro-optic polarization range of tourmaline in all electronic transition bands, reaches spaces of radio frequency from 03 kHz to 300 GHz and from ≦7 kHz to 720 GHz negative waves of reversed bands, converting electromagnetic charges with positive ions (cations) into negative ions (anions) gravitons, and converts the electromagnetic waves at the generation source and reception in its action radius throughout the solar system, produces the pre-electronic environment, decontaminated air, the Battery applied to electrical systems converts the electromagnetic waves with positive ions (cations) into negative ions (anions), Irradiates MagnetoHydroresonating Active Effect, whenever there is a change of physical/chemical state, movements of liquid solids within this ionizing field the energy transfer is perpetuated in the medium.

45. Technical application of the battery in mineral, plant and animal kingdoms, conversion process of photoelectric energy of natural light, according to claim 5, wherein it is radiated by active diffusers acting from the installation point in the direction of electrons or molecules flow, through electrical cables and wires, powered, radio frequency signals, duct water, air flow, combustion air flow, cooling elements flow, combustion flame flow, and applied on inert diffuser metallic, plastic and polyester wires and cables, acts or radiates in both directions in helical motion with a 6 m diameter, and produces a pre-electronic environment.

46. Technical application of the battery in mineral, plant and animal kingdoms according to claims 5 and 6, for rotary and alternating movements cycles combustion systems, Otto, Diesel, Braytone, external combustion systems, cooking systems and others, wherein it is extracting energy from astrophysical Air/Light fixating it in physical/chemical hydrogen activities, this will transmute the atomic structure, trigger an energy field that works in electromagnetic conversion of positive ions into negative (anions), maintains the string synchrony in perpetual pulsing, produces the materialization of light, maintains electromagnetic space-time, quantum vacuum, randomizing connector, acts refocusing all the energy to a new hyper-dimensional orbital field, permanently neutralizing the combination of combustion component elements, and in the systems of internal combustion Otto cycle, Diesel and Braytoni applied in the air intake, in the engine's fuel hose/duct or supply pump's hose/duct, reduces emissions by between 35 an 60% of greenhouse gases GHG such as HC, CO, CO₂, NO₂, NOx, SOx, O₃, benzene, dioxins and MP and the remaining gases emitted are of negative electromagnetic charge anions, reduces fuel consumption from 05 to 15% ionizes fuel during the supply process at the Stations which produces reduction in emissions from 35 to 40% and reduces the consumption of fuel from 05 to 15%

47. Technical application of battery in mineral, plant and animal kingdoms, according to claims 5, 6 and 7, for usage in cooking combustion systems, and external combustion system, wherein it is in the form of clamp on the hose/gas duct, combustion curtain with cut-outs in the air combustion outlet, solids, liquids and gases, reduces by over 30% the emission of greenhouse gases GHG, Particulate Matter, possible carbon credit, produces low contamination ashes of industrial use, quality ashes for superior cement manufacturing and reduces the consumption between 5 and 15%.

48. Technical application of battery in mineral, plant and animal kingdoms, according to claims 5, 6 and 7, for usage in electricity systems applied without physical contact with conductive metals, fixated on cables or on the cover of the switchboard, and or through Hydroresonating s ionizing strips and wires, wherein it reduces the generation of harmonics, converting the positive ions generated by the electromagnetic field into negative ions and diffuses throughout the electric circuit, reduces the generation of harmonics, harmonize and synchronizes the relation between supply and system charge, reduces losses and reduces the power consumption between 5 and 15%, MagnetoHydroresonating active effect, produces changes in all processes of welding, MIG/MAG type electric welding, reduces emissions of fumes and gases by 60.5%, increased penetration of the chord and Vickers hardness.

49. Technical application of battery in mineral, plant and animal kingdoms, according to claims 5, 6 7 and 8, for usage in communication systems applied to continuous and/or alternating electric energy which feeds the equipment that generates radio signals, wherein it converts at the generation source signals from radio broadcast, audio, video, images, data, internet, cell phone system, GPS and satellites, in any band range or reverse band are converted form source of positive ions (cations) into negative ions (anions), are transmitted/retransmitted (by repeaters), and received in negative ions, improves the quality of the audio, data, image and internet signal, extends the range of the audio, images and data, signals reduces the shadow area of radio, television, cell phones by harmonizing and synchronizing the whole system, and transmitted via ether charges the biosphere with negative ions, in the form of pulsating perpetuating strings, that act on greenhouse gas GHG reduces acid rains restores the low level ozone layer, electromagnetic radiation crudeness on plants and animals, protecting the guidance system of insects atmosphere and creating a pre-electronic environment.

50. Technical application of the battery in mineral, plant and animal kingdoms, according to claims 5, 6, 7 and 9 to be applied to any electrical system and combustion in smelting, processing and injection, wherein occurs transference of parts of the properties the MagnetoHydroresonating active effect, on products originated in steel melting, noble alloys, ferrosilicon, hard aluminum, rock crushing and grinding, solid fuel, in the melting and injection of “Natural Lightweight Plastic TR 15/50” beads, in vulcanization and injection of rubber and products, in the production line of manufactured rubber products, retrieves the natural latex, elasticity, fatigue resistance, improved shore-A hardness, mattia flexure strength, abrasion resistance, impact resistance, compression, shear and traction, also is imbued with part of the technology, starts emitting negative ions (anions), permanently and perpetuating.

51. Technical application of the battery in mineral, plant and animal kingdoms, according to claims 5, 6 and 7, for use in water treatment and consumption systems, residential, commercial, industrial and irrigation, wherein is applied in the duct in external form, without contact with the liquid, the water impregnates with the MagnetoHydroresonating Active Effect, performs the Negative ionization, produces better conductivity, flow, turbidity, stabilizes the pH to basic, reduces odors, dissolves the salt complexes, (bicarbonates, sulfates, chlorides and nitrates “stone milk”), breaks the hardness (softening), reduces fouling, increases the drinkability, increases the production of cultivars treated with irrigation, in washing processes, reduces the use of soap and softeners, in construction, concrete with greater hardness and greater imperviousness.

52. Technical application of the battery in mineral, plant and animal kingdoms, according to claims 5, 6, 7, 9, 11 and 12, with the action of the MagnetoHydroresonating active effect in geobiological protection, wherein the protection of Geobiology, the MagnetoHydroresonating Active Effect are applied directly to the soil or through an inert/active diffuser neutralizes anomalies of the ground's electrical differential, fixates the electrostatic constant, reduce the emission of telluric rays caused by cracks, fissures, faults in the subsoil, underground water currents, buried electrical lines, ionizing effects of radon gas, molds, yeasts and fungi, producing environments for human use, animal husbandry and healthy planting areas.

53. Technical application of the battery in the mineral, plant and animal kingdoms, according to claims 5, 6, 7, 9, 11, 12 and 13 and that, in agriculture systems applied in inert and active diffusing vectors it's wherein diffuses the MagnetoHydroresonating Active Effect, enhancing photosynthesis, blocking electromagnetic radiation, providing negative ions in the air and soil, increase absorption of micro nutrients from the air and soil, improve the phyto tonic effect, carbonic connection, ramifications of the roots and branches of capillaries, larger leaf mass and chlorophyll, enabling to absorb and fixate nitrogen, improve productive and reproductive capacity, increasing brix degree of fruit and stems, producing more nutritious fruits, stems, grains, seeds and horticultural products with higher energy content of up to 8,100 A°, increase the absorption of carbon CO₂, releases more oxygen O2 per hectare and produce more abundant crops above 10% average,—in cultures of sugarcane and sorghum produces higher stalk mass, Brix degree, alcohol and sugar per ton hectare, in seedling multiplication and treated seeds, the MagnetoHydroresonating Active Effect, incorporates in seeds and seedlings' genes properties of the MagnetoHydroresonating Active Effect technology, parts of the property that are fixated and manifested until the third generation, in cereal crops, leguminous and grasses, produce higher levels of oil with lower acidity, grain with greater gluten force, (W) above, increases the productive and reproductive capacities, reduces the incidence of fungi, molds, yeasts and bacteria in storage in saddlers; in manufacturing and transformation processes the product originated impregnates itself of parts of the MagnetoHydroresonating Active Effect during the industrial action of drying ovens, cooking, on the manufacturing and transformation of distilled beverages, fermented, natural juices, edible oils, from wheat derivatives, from the cocoa for the production of chocolate, from the coffee bean in the roasting and grinding processes, in juices obtained from fruits, occurs the same impregnation process; in cultures of sugar cane and vines, during the whole production cycle, through diffusing vectors, the MagnetoHydroresonating Active Effect irradiated remains active after the fermentation and distillation of fruits, cereals and stalks, produces beverages and derivatives, with the ability to emit negative ions permanently.

54. Technical application battery in kingdoms mineral, vegetable and animal, according to claims 5, 6, 7, 9, 11, 12, 13 and 14, being the action of the active effect MagnetoHydroresonating fundamental resonant particles that interact in physical and chemical processes in humans and animals by the laws of Constancy, wherein it accelerates some and slows others down, such as DNA, RNA, improves immune system, reduces free radicals, premature aging, puts in harmonic resonance the balance of natural biorhythms, vitaminizes the air, activates the brain's Beta Endorphins, ionized blood with basic Ph, increases stamina/physical strength, stimulates the production of β-endorphins, improves biological functions, with restful sleep, stress reducer, good mood, activation of cells, metabolism acceleration, psychomotor performance, blood circulation, ratiocination, concentration, recovery from fatigue, strengthens the immune system, improves performance and productivity, with consequent improvement in quality of life, removes the environment's insalubrity keeps the air pure and vitaminized, normalizes the autonomic nervous or motor system and produces an invigorating effect on living bodies.
